(19) United States
(12) Patent Application Publication
(10) Pub. No.: US 2026/0331944 A1
(43) Pub. Date: Oct. 22, 2026

(54) PARALLEL HYBRID ENERGY SYSTEM

(71) Applicant: Alliance North America, Inc, Henderson, NV (US)

(72) Inventors: Travis Waineo, Henderson, NV (US); Michael Yin, Henderson, NV (US); Jeremy A. Goddard, Henderson, NV (US); Thomas J. Caterina, Sun Lakes, AZ (US); Michael F. Niemela, Henderson, NV (US); Gregory McFadden, Las Vegas, NV (US); Warren J. Krettek, Henderson, NV (US); Kevin Speach, Henderson, NV (US)

(21) Appl. No.: 19/730,197

(22) Filed: Jul. 2, 2026

Related U.S. Application Data
(63) Continuation-in-part of application No. 19/458,060, filed on Jan. 23, 2026.
(60) Provisional application No. 63/769,507, filed on Mar. 10, 2025.
(60) Provisional application No. 63/838,207, filed on Jul. 3, 2025.

(51) Int. Cl. H02J 9/08; H02J 7/00; H02J 7/02; H02J 9/06; H02J 101/40

(52) U.S. Cl. CPC H02J 9/08; H02J 7/02; H02J 7/855; H02J 9/061; H02J 9/062; H02J 2101/40; H02J 2207/20

(57) ABSTRACT

A system for backup power to a load includes an engine, an alternator, a battery, an inverter, a switch, and a controller. The engine rotates the alternator to power a load. The inverter is coupled to a grid. The inverter operates in a passthrough mode such that the grid powers the load and charges the battery. The switch couples the power grid or the alternator to the load. The controller controls the engine and the switch. The controller receives a signal when grid power is lost. When the signal is received, the controller initiates engine startup such that the engine rotates the alternator to supply power to the load. The controller commands the switch to couple the alternator output to the load after engine warmup. The inverter operates in an uninterruptible mode when grid power is lost, such that battery power, via the inverter, powers a critical load.

### CROSS REFERENCE TO RELATED APPLICATION

The present application is a continuation-in-part of U.S. patent application Ser. No. 19/458,060, filed Jan. 23, 2026, which claims the filing benefits of U.S. provisional application Ser. No. 63/769,507, filed Mar. 10, 2025, and also claims the filing benefits of U.S. provisional application Ser. No. 63/838,207, filed Jul. 3, 2025, which are all hereby incorporated by reference herein in their entireties.

### FIELD OF THE INVENTION

The present invention is directed to battery systems, power generation, system controls, and in particular to battery storage systems in combination with generators in mobile and stationary applications.

### BACKGROUND OF THE INVENTION

Generators are often driven by engines, such as diesel engines, and other engines using a variety of fuels, e.g., propane, natural gas, gasoline, biodiesel, and hydrogen.

### SUMMARY OF THE INVENTION

Embodiments of the present invention provide a hybrid energy system for managing an operational environment of an engine-driven generator. Example engines include a variety of fuel sources, for example, diesel, propane, natural gas, gasoline, biodiesel, and hydrogen. A hybrid energy system improves the efficiency of an engine-powered generator by running the engine (of the generator) at its optimal load and reducing the engine's run time by storing unused power (of the generator), or power the generator is capable of producing that is more than the load requires, in a battery. In an aspect of the present invention, the hybrid energy system is an engine-generator optimizing, mechanically coupled, parallel hybrid energy system. The parallel hybrid energy system includes an engine, batteries, a bidirectional inverter or converter, an electric motor, and an alternator. The alternator is mechanically coupled to an engine, e.g., diesel, propane, turbine, or fuel agnostic engine via an electronically controlled clutch. When the hybrid energy system outputs power to a load, in one mode (a discharge mode) the batteries power the load by powering the electric motor through the bidirectional inverter or converter. Mechanically coupled to the alternator, the electric motor generates power for the load by rotating the alternator. When the batteries reach a minimum state of charge, in a second mode (a recharge mode) the engine is started and the clutch is engaged (and the electric motor is no longer turning the alternator). With the engine running, the batteries will be recharged from power output from the electric motor (which is rotated by the engine), and the load will be powered via the alternator (spun by the engine). The engine will continue running until the battery reaches a maximum state of charge. When the battery is fully charged (or reaches a threshold state of charge) the system may return to the discharge mode, where the clutch is disengaged, the engine turned off, and the batteries engaged to power the electric motor to power the load via the electric motor spinning the alternator. The operation of the parallel hybrid energy system (e.g., engagement and disengagement of clutch, starting/stopping the engine, and either outputting power to the electric motor or outputting power from the electric motor to recharge the battery) is controlled with a controller.

In an aspect of the present invention, an exemplary uninterruptible power supply (UPS)/parallel hybrid energy system for providing backup power to a load, and uninterruptable power to a critical load comprises an engine, an alternator, an electric motor, a battery, a first bidirectional converter, a power switch, and a controller. The engine is configured to rotate the alternator. The alternator is configured to output a voltage output to a load when rotated. The first bidirectional device is communicatively coupled to a power grid, wherein the first bidirectional device is configured to operate in a passthrough mode, wherein the power grid, via the first bidirectional device, is configured to power the load and to charge the battery while the first bidirectional device is in the passthrough mode. The power switch is configured to selectively couple either the power grid or the alternator to the load for powering the load. The controller is configured to control the engine and the power switch. The controller is also configured to receive a power loss signal when power is lost from the power grid. The controller, in response to receiving the power loss signal, is configured to initiate an engine startup such that the engine will rotate the alternator to supply backup power to the load, wherein the controller is configured to command the power switch to couple an output from the alternator to power the load once the engine has warmed up. The first bidirectional device is configured to operate in an uninterruptible mode when power from the power grid is lost, such that power from the battery is provided via the first bidirectional device to at least one critical load.

In another aspect of the present invention, an exemplary parallel hybrid energy system for powering a load includes an engine, a clutch, an electric motor, an alternator, a bidirectional inverter or converter, and a battery bank. The engine is coupled to the electric motor via the clutch, and with the electric motor coupled to the alternator, such that when the engine is running and the clutch is engaged, the electric motor and the alternator will be spun by the engine. With the engine running, the alternator will output power to a load (when load contactors are closed) and the electric motor will output power to recharge the battery pack via the bidirectional inverter or converter. When the battery is fully charged, the engine can be turned off, the clutch opened, and the electric motor powered by the battery pack. With the electric motor running and rotating the alternator, the alternator will continue powering the load (while the load contactors are closed). The battery will continue running the electric motor until the battery pack reaches a lower charge threshold. When the battery pack is depleted, the engine will be restarted to power the load and recharge the battery pack (by spinning the electric motor).

In yet another aspect of the present invention, the parallel hybrid energy system is configured to work with any fuel-type engine, such as propane, natural gas, gasoline, ethanol, biodiesel, or hydrogen. In aspects of the present invention, the parallel hybrid energy system is configured to work with any type of engine (e.g., internal combustion, turbine engine, and the like)

In an aspect of the present invention, the parallel hybrid energy system includes a controller for controlling the operation of the engine, the motor, the clutch, the bidirectional inverter or converter, and the battery pack, and the load contactors.

Other embodiments of the present invention provide a UPS/parallel hybrid energy system, where a grid-tied inverter, receiving power from a battery of the UPS/parallel hybrid energy system, provides uninterruptible backup power to one or more critical loads of loads (e.g., critical DC loads and/or critical AC loads) powered by the UPS/parallel hybrid energy system. When a generator is in standby or backup mode, the controls are on and powered, but the engine and alternator are not rotating and generating electricity. One of the benefits of an exemplary UPS/parallel hybrid energy system described herein is in the event of a power outage, a signal (typically from an automatic transfer switch (ATS)) is provided to the controller that drives the electric motor to quickly spin the alternator to the desired speed to make backup power available during or even before the engine even starts. This allows the engine time to start up and warm up properly without having to provide backup power without a proper warmup, which is not ideal or is bad for the engine. The standard parallel hybrid energy system alone provides such backup power much more quickly than a traditional backup generator, but there will still be an interruption of power due to the ATS switching from grid power (utility power) and signaling for the parallel hybrid energy system to start. For critical load situations where the power must not be interrupted, an exemplary UPS system of the UPS/parallel hybrid energy system provides uninterruptible power to a critical load. By integrating a grid-tied inverter to the UPS/parallel hybrid energy system, the grid-tied inverter is connected to the grid and is able to detect a power outage.

When grid power is available, the parallel hybrid energy system is on standby and the grid-tied inverter is able to charge and keep the batteries topped off and having grid power passthrough to keep the critical loads on.

When grid power is out, the inverter detects this and is able to switch from a pass through mode to a power production mode to power the critical load(s) without interruption to the critical loads connected to the integrated UPS system.

When the grid power is restored, the grid-tied inverter monitors the grid's voltage level(s) and frequency and then adjusts its own output to match both the phase and frequency (sync) before connecting and allowing passthrough.

Embodiments of this UPS system utilize the onboard batteries on the parallel hybrid energy system so there is no need for additional or separate batteries which may cause added expense and complexity. Due to the ability of the parallel hybrid energy system to power on and provide backup power much quicker than a regular standby generator, a large UPS battery is not required and, in this case, it uses the onboard batteries of the parallel hybrid energy system. Added redundancy and/or added power capability is achievable by paralleling more than one parallel hybrid energy system together. This approach to backup/standby UPS power generation can be much more cost effective than conventional UPS systems and easier to integrate in an application.

In an aspect of the present invention, an exemplary energy system for providing backup power to a load includes an engine, an alternator, a battery, an inverter, a switch, and a controller. The engine rotates the alternator which outputs a voltage output to a load when rotated. The inverter is coupled to a power grid. The inverter is configured to operate in a passthrough mode for powering the load and charging the battery. The switch is for selectively coupling either the power grid or the alternator to the load to power the load. The controller controls the engine and the switch. The controller receives a power loss signal when power is lost from the power grid. When the power loss signal is received, the controller will initiate an engine startup such that the engine rotates the alternator to supply power to the load. The controller commands the switch to couple the alternator output to the load once the engine has warmed up. The inverter operates in an uninterruptible mode when grid power is lost, such that power from the battery is provided by the inverter to a critical load (e.g., critical AC loads and/or critical DC loads).

Thus, the exemplary embodiments discussed herein improve the efficiency of an engine and alternator assembly (e.g., a diesel generator) with the inclusion of an electric motor and battery or batteries. To provide uninterrupted power to critical loads (e.g., critical DC loads and/or critical AC loads), a UPS system is also included. Such a system (e.g., a UPS/parallel hybrid energy system) supplies power to AC and/or DC loads as well as uninterrupted power to critical loads (e.g., critical AC loads and/or critical DC loads). The batteries of the parallel hybrid energy system are used by the UPS system, with the batteries recharged by either a grid connection or by the parallel hybrid energy system (e.g., an alternator). In accordance with the various configurations described herein, power from the UPS/parallel hybrid energy system can come from the engine, the electric motor/batteries, or the grid, ensuring reliable supply of both AC and DC loads, with automatic switching and charging capabilities. An automatic transfer switch (ATS) may also be included for routing AC power to the AC load, with the ATS interfacing with the grid, ensuring backup power and automatic switching (between grid power and backup power). A controller of the UPS/parallel hybrid energy system coordinates engine start/stop, motor engagement, battery charging, and switching logic. Lastly, as described herein, the UPS/parallel hybrid energy system is configured to operate in a variety of modes: an engine mode where the engine drives the alternator, supplying AC power to AC loads and charges the batteries. A grid mode where the grid powers AC loads directly and recharges the batteries. A backup mode where the batteries supply power to DC loads via a DC/DC converter if the AC/grid fails.

These and other objects, advantages, purposes, and features of the present invention will become apparent upon review of the following specification in conjunction with the drawings.

### BRIEF DESCRIPTION OF THE DRAWINGS

FIG. 1A is a block diagram illustrating an exemplary parallel hybrid energy system with an engine mechanically coupled via a clutching mechanism to an electric motor and an alternator, with the electric motor electrically coupled to a motor controller and batteries in accordance with the present invention;

FIG. 1B is a block diagram illustrating another example implementation of the parallel hybrid energy system in accordance with aspects of the present invention;

FIG. 2A is a block diagram illustrating another example implementation of the parallel hybrid energy system incorporating a single output gearbox between the engine, electric motor, and alternator in accordance with aspects of the present invention;

FIG. 2B is a block diagram illustrating another example implementation of the parallel hybrid energy system incorporating a single output gearbox between the engine, electric motor, and alternator in accordance with aspects of the present invention;

FIG. 2C is a block diagram illustrating another example implementation of the parallel hybrid energy system incorporating a chain drive in accordance with the present invention;

FIG. 2D is a block diagram illustrating another example implementation of the parallel hybrid energy system incorporating a chain drive in accordance with the present invention;

FIG. 2E is a block diagram illustrating another example implementation of the parallel hybrid energy system incorporating a belt drive in accordance with the present invention;

FIG. 2F is a block diagram illustrating another example implementation of the parallel hybrid energy system incorporating a belt drive in accordance with the present invention;

FIG. 3A is a block diagram illustrating another example implementation of the parallel hybrid energy system incorporating a dual output gearbox between the engine, electric motor, and alternator in accordance with the present invention;

FIG. 3B is a block diagram illustrating another example implementation of the parallel hybrid energy system incorporating a dual output gearbox between the engine, electric motor, and alternator in accordance with the present invention;

FIG. 3C is a block diagram illustrating another exemplary implementation of the parallel hybrid energy system incorporating gear reducer/overdrives in accordance with the present invention;

FIG. 3D is a block diagram illustrating yet another exemplary implementation of the parallel hybrid energy system incorporating gear reducer/overdrives in accordance with the present invention;

FIG. 4A is a block diagram illustrating another example implementation of the parallel hybrid energy system incorporating an exemplary two or more electric motors in accordance with the present invention;

FIG. 4B is a block diagram illustrating another example implementation of the parallel hybrid energy system incorporating an another exemplary two or more electric motors in accordance with the present invention;

FIG. 4C is a block diagram illustrating another example implementation of the parallel hybrid energy system incorporating yet another exemplary two or more electric motors in accordance with the present invention;

FIG. 5A is a block diagram illustrating an exemplary inertial energy storage flywheel in accordance with the present invention;

FIG. 5B is a block diagram illustrating another exemplary inertial energy storage flywheel in accordance with the present invention;

FIG. 5C is a block diagram illustrating yet another exemplary inertial energy storage flywheel in accordance with the present invention;

FIG. 5D is a block diagram illustrating an exemplary embodiment that incorporates multiple electric motors and a planetary gearbox in accordance with the present invention;

FIG. 6A is a block diagram illustrating an exemplary packaging configuration for the electric motor, motor controller, and clutching mechanism in accordance with the present invention;

FIG. 6B is a block diagram illustrating another exemplary packaging configuration for the electric motor, motor controller, and clutching mechanism in accordance with the present invention;

FIG. 6C is a block diagram illustrating yet another exemplary packaging configuration for the electric motor, motor controller, and clutching mechanism in accordance with the present invention;

FIG. 6D is a block diagram illustrating yet another alternative exemplary packaging configuration for the electric motor, motor controller, and clutching mechanism in accordance with the present invention;

FIG. 6E is a block diagram illustrating yet another alternative exemplary packaging configuration for the electric motor, motor controller, batteries, and clutching mechanism in accordance with the present invention;

FIG. 7 is a block diagram illustrating an exemplary embodiment that incorporates an external supercapacitor and/or an external battery in accordance with the present invention;

FIG. 8A is a block diagram illustrating an exemplary embodiment that incorporates a clutching mechanism between the engine assembly and electric motor and a clutching mechanism between the electric motor and an alternator in accordance with the present invention;

FIG. 8B is a block diagram illustrating a standby process for an exemplary embodiment of the parallel hybrid energy system that incorporates an automatic transfer switch for switching a load from utility power to backup generator power in accordance with the present invention;

FIG. 9A is a block diagram illustrating operation of the parallel hybrid energy system in an exemplary discharge mode in accordance with the present invention;

FIG. 9B is a block diagram illustrating operation of the parallel hybrid energy system in an exemplary charge mode in accordance with the present invention;

FIG. 9C is a block diagram illustrating operation of the parallel hybrid energy system in an exemplary peak power mode in accordance with the present invention;

FIG. 9D is a block diagram illustrating operation of the parallel hybrid energy system in an exemplary fault bypass mode in accordance with the present invention;

FIG. 9E is a block diagram illustrating operation of the parallel hybrid energy system in an exemplary environmental conditions bypass mode in accordance with the present invention;

FIG. 10 is a block diagram illustrating an exemplary embodiment of an uninterruptible power supply (UPS)/Parallel Hybrid Energy system that integrates a UPS and related controls with a parallel hybrid energy system in accordance with the present invention;

FIG. 11 is a block diagram of an alternative UPS/Parallel Hybrid Energy system that integrates a UPS and related controls with a parallel hybrid energy system and illustrating an exemplary arrangement for supplying critical AC loads and critical DC loads in accordance with the present invention;

FIGS. 12 and 13 are flow diagrams illustrating steps to methods for starting the parallel hybrid energy system following startup procedures in accordance with the present invention; and

FIG. 14 is a block diagram of an alternative UPS/Parallel Hybrid Energy system that integrates a UPS and related controls with a plurality of parallel hybrid energy systems and illustrating an exemplary arrangement for supplying critical AC loads and/or critical DC loads in accordance with the present invention.

### DESCRIPTION OF THE PREFERRED EMBODIMENTS

Referring to the drawings and the illustrative embodiments depicted therein, a parallel hybrid energy system provides for the elimination or reduction of loading issues on engine driven generators and a more efficient supply of power to a load from the alternator mechanically coupled to both an engine and an electric motor. Such engines may be powered by a variety of fuels, for example, diesel, propane, natural gas, gasoline, biodiesel, and hydrogen. The engines include, for example, exemplary diesel engines suitable for driving generators (alternators), such as, for example, EPA Tier 4F certified or other similarly compliant diesel engine driven mobile generators (as well as Stage 5 or higher). The engines may be configured in a variety of options, such as internal combustion engines, turbines, and the like. Such electric motors may be configured as AC or DC motors and driven by a battery source via a bidirectional motor controller. It is understood that a “bidirectional” motor controller, when paired with an AC motor, is configured to output DC voltage when operating in one direction (i.e., operating in one direction), and output AC voltage when outputting in the opposite direction (i.e., operating in the opposite direction). Whereas the “bidirectional” motor controller provides DC to DC conversion with different voltages when paired with a DC motor. The parallel hybrid energy system also provides for the powering down of the engine (e.g., diesel engine) while the batteries of the parallel hybrid energy system provide power. As described herein, battery power (via a bidirectional motor controller) is used to energize the electric motor mechanically coupled to the alternator and thereby supply power from the alternator to the load. Exemplary parallel hybrid energy systems utilize one or more electric motors, one or more bidirectional motor controllers, and the components of the parallel hybrid energy system may be configured in a variety of different arrangements (including physical arrangements of the components) depending on needs and desirability. A hybrid energy system utilizing an engine-driven generator coupled to an alternative power source (e.g., a battery bank) is described in detail in Applicant's own U.S. Patent Application Publication No. 2023/0378766, which is hereby incorporated by reference herein in its entirety.

When properly loaded, a diesel engine provides an efficient driver for a generator. When lightly loaded, diesel engines can be inefficient and susceptible to wet stacking (i.e., when unburnt diesel fuel passes into the diesel exhaust system and produces an oily residue). Wet stacking happens when a diesel engine is running at a low percentage or proportion of its capacity. For example, a diesel engine coupled to a generator is susceptible to wet stacking when the generator it is driving has no load or only a minimal load coupled to it; in addition, the generator operates less efficiently (more fuel is consumed per kwh produced versus an optimally loaded generator). When the generator is operating with no load or only a minimal load, the diesel engine is operating in an inefficient manner, resulting in the risk of wet stacking because the diesel engine is not at a proper operating temperature (allowing unburnt fuel to escape into the diesel exhaust system). Diesel engines are most efficient when they are running at a sufficient percentage or proportion of their full capacity. When a diesel engine is running under a sufficient load, the diesel engine can run at an optimum operating temperature. Generators used to power electrical equipment typically see variable loads through their normal usage intervals. To aid in the prevention of wet stacking of diesel engines coupled to generators, dummy loads or load banks can be applied to their generators.

Standby generators are commonly used to provide backup power when an energy grid or the like is out. In order to comply with certain regulations, these standby generators need to provide backup power within a certain timeframe in the event of a power outage. For many critical load applications, an interruption of power is unacceptable and thus there are uninterruptible power systems (UPS) in place that ensure no interruption of power during an outage. These UPSs traditionally include grid-tied inverters and energy storage batteries.

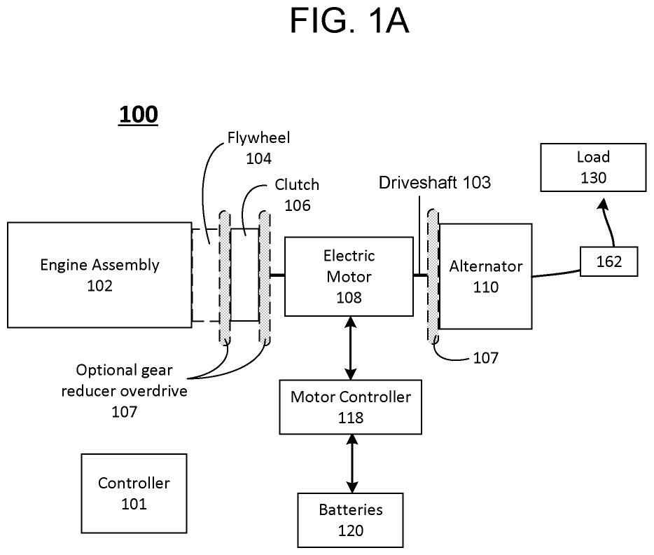

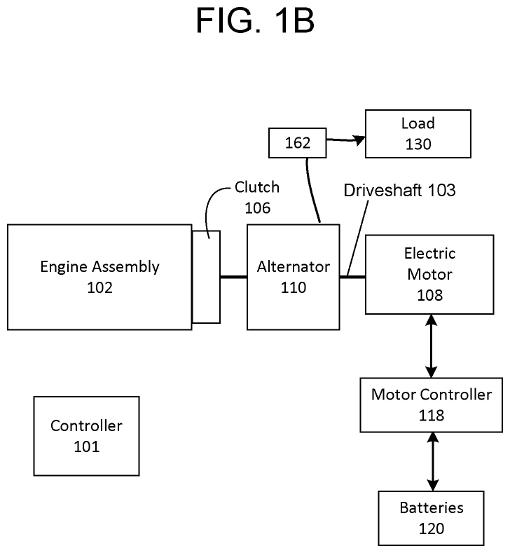

As described herein, exemplary embodiments of a parallel hybrid energy system 100 provide for an engine-generator system that outputs AC power to a load (e.g., load 130) at a desired voltage and frequency (see FIG. 1A). The parallel hybrid energy system 100 includes an engine (e.g., engine 102) configured to run at a desired revolutions per minute (RPM) needed to ensure a mechanically-coupled alternator (e.g., alternator 110) is moving or rotating at a rotational rate (RPM) to produce the desired voltage and frequency (e.g., 50, 60, 400 Hz) needed to generate the desired alternating current (AC) power. The AC output of the alternator 110 may be, for example, 120 volts alternating current (VAC), 208VAC, 480VAC or 240 VAC power. As illustrated and discussed herein, the engine 102 is coupled to an electric motor 108 and the alternator 110 via an electrically controlled or mechanically actuated (over-running) clutching mechanism 106. In one embodiment, the clutching mechanism (e.g., clutch 106) is electrically controlled by a controller 101. In one embodiment, the components (e.g., engine 102, clutch 106, electric motor 108, and alternator 110) are directly mechanically coupled to each other. In another embodiment, the components are mechanically coupled with the use of a driveshaft or driveline (e.g., driveshaft 103) (see FIGS. 1A and 1B). In another embodiment, the components are mechanically coupled using a combination of direct coupling and a driveshaft (e.g., driveshaft 103).

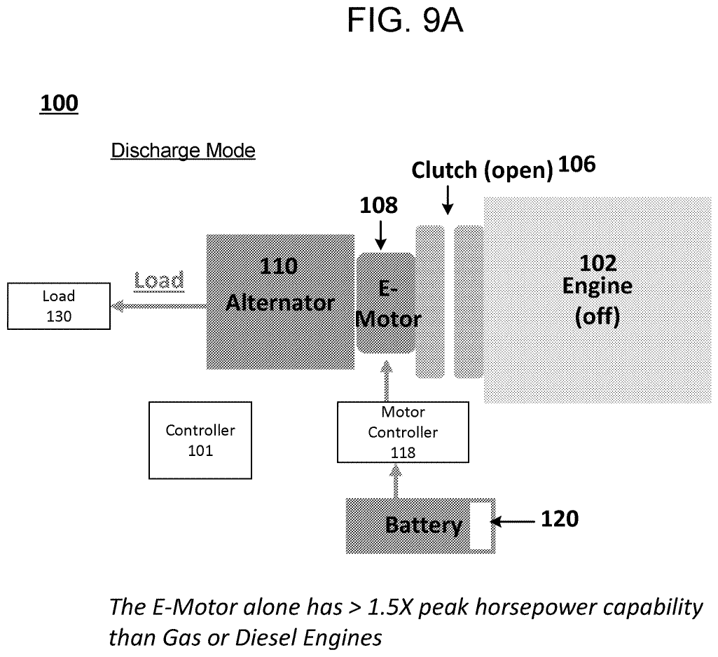

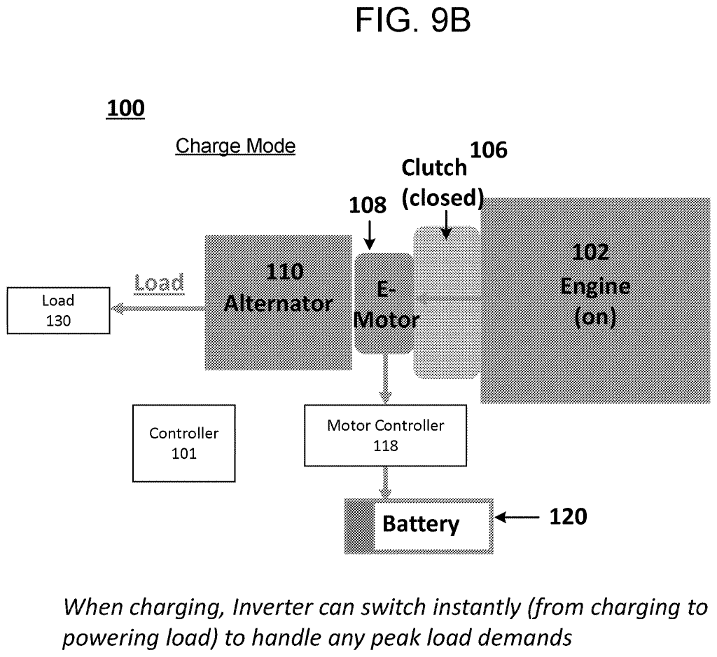

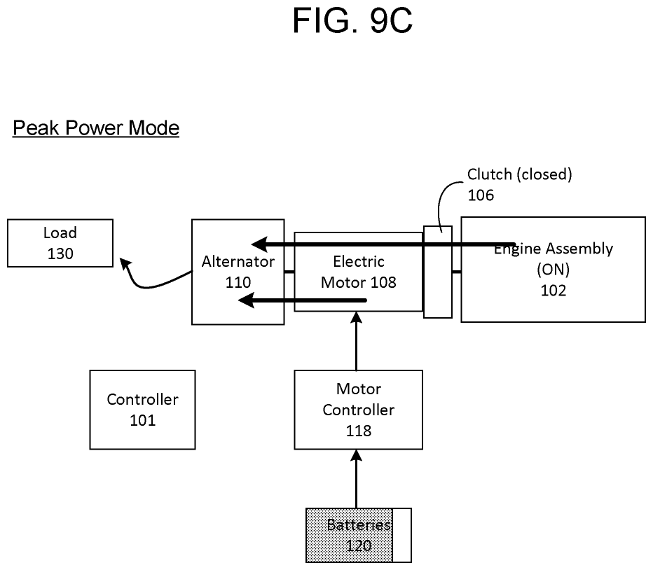

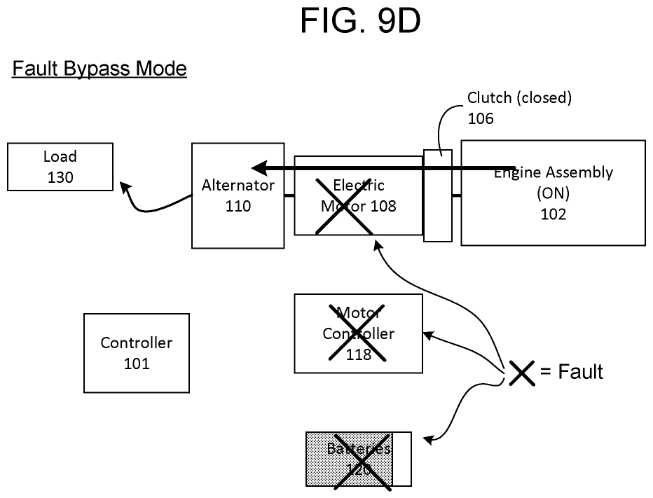

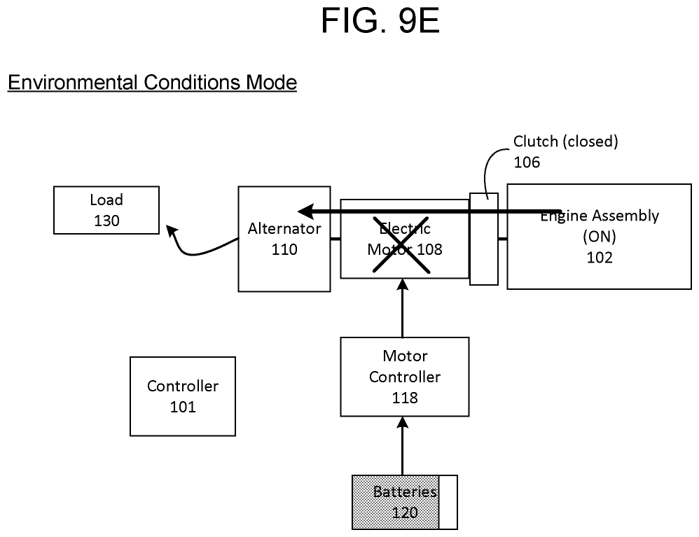

Referring to FIGS. 1A and 1B, an exemplary parallel hybrid energy system 100 includes an alternator 110 that is attached to an electric motor 108 and a clutching mechanism 106 (which may also be referred to as a clutch 106). The clutching mechanism 106 may engage or disengage with a flywheel 104 on the engine 102. In some embodiments, the flywheel 104 may be a part of the engine 102 or coupled to the engine 102 (see FIG. 1A). As described herein, the parallel hybrid energy system 100 can power a load (e.g., load 130) with the engine 102 off and the clutch 104 disengaged, such that the electric motor 108, while powered by a battery 120 output, will move (e.g., rotate) the alternator 110 to produce the desired voltage and frequency (see FIG. 9A). Likewise, the parallel hybrid energy system 100 can power the load 130 with the engine 102 running and the clutch 106 engaged/closed. When the engine 102 is running and the clutch 106 is engaged/closed, the parallel hybrid energy system 100 can power the load 130 while also charging the batteries 108 (see FIG. 9B). As illustrated in FIGS. 1A and 1B, when the engine 102 is running and the clutch 106 is engaged, the engine 102 will be mechanically coupled to the electric motor 108 (which is mechanically coupled to the alternator 110). By the engine 102 rotating the electric motor 108, an electrical power is generated by the electric motor 108 which is used to recharge the batteries 120 (via a motor controller 118). As discussed herein, with the electric motor 108 rotating the alternator 110 (when powered by the batteries 120), backup power can be provided to a load 130 when grid power is lost even while the engine 102 is warming up and preparing to provide the needed backup power after the grid power loss. As illustrated in FIG. 1A, in one exemplary embodiment, the engine assembly 102 is mechanically coupled to an electric motor 108, which is mechanically coupled to an alternator 110, while in an alternative embodiment illustrated in FIG. 1B, the engine assembly 102 is mechanically coupled to the alternator 110, which is mechanically coupled to the electric motor 108. As illustrated in FIGS. 1A, 1B, 2A, 2B, and 3A-3D, a flywheel 104, clutch mechanism 106, and/or gear reducer overdrive 107 may be positioned between selected components of the parallel hybrid energy system 100.

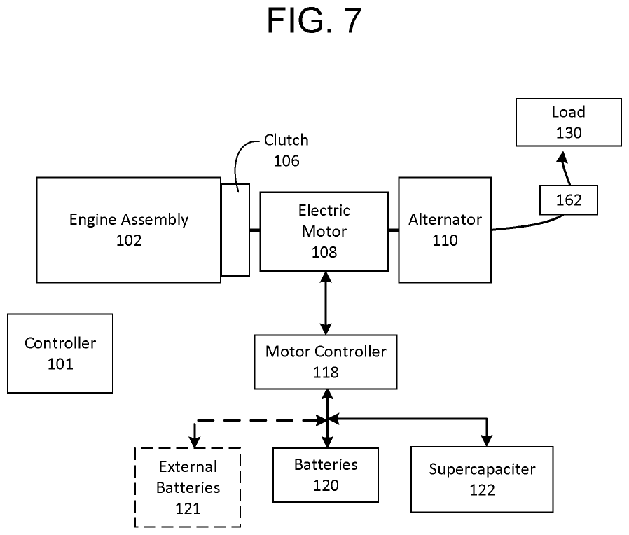

Referring to FIG. 7, an exemplary parallel hybrid energy system embodiment 100 may optionally include one or more supercapacitors 122, in place of, or in addition to the batteries (e.g., batteries 120). As also illustrated in FIG. 7, the batteries 120 may also be optionally supplemented with external batteries 121 (of a similar or different battery technology). Another exemplary parallel hybrid energy system embodiment 100 replaces the conventional engine assembly 102 (e.g., a diesel engine) with an exemplary gas turbine.

The motor controller 118 is a bidirectional device (see FIGS. 9A and 9B). Thus, when the batteries 120 are being charged, power is passing through the motor controller 118 and towards the batteries 120. When the batteries 120 are outputting power to the electric motor 108, power is passing through the motor controller 118 in the other direction and towards the electric motor 108. When the batteries 120 have been fully charged, or sufficiently charged (with reference to a charge threshold or other criteria for determining a charge state of the batteries 108), the parallel hybrid energy system 100 (e.g., controller 101) disengages (opens) the clutch 108 and shuts down the engine 102. When the battery 108 is nearly depleted (e.g., to a charge level at or below 10%) or if a significantly high load (e.g., load 130) is detected, the controller 101 of the parallel hybrid energy system 100 turns on the engine 102 and engages the clutch 106. While the engine 102 is running, the engine 102 is supporting the load (e.g., load 130) and also rotating the electric motor 108 to charge the batteries 120 (with the power output from the electric motor 108, via the motor controller 118). If there is a sudden very high load such as motor starting (e.g., higher than what the engine 102 alone can handle), in peak power mode, the controller 101 can direct the motor controller 118 to stop charging the batteries 120 and start running the engine 102 in parallel with the electric motor 108 to power the unusually high load (See FIG. 9C). That is, if there is a sufficient charge in the battery 120, the controller 101 may select a peak power mode where both the engine 102 and the electric motor 108 (with the batteries 120 powering the electric motor 108 via the motor controller 118) can be used in parallel to rotate the alternator 110 together and supply the higher load demanded (e.g., load 130).

As discussed herein, the operations of the parallel hybrid energy system 100 (e.g., engagement and disengagement of clutch 106, starting/stopping the engine 102, and outputting power to the electric motor 108 or recharging the battery 120) are controlled by a controller 101. While a plurality of batteries 120 are illustrated, it is understood that one or more batteries of the same or different type(s) are anticipated. The batteries 120 may be of any desired chemistry or configuration (e.g., lead-acid batteries, lithium-titanium-oxide (LTO) batteries, lithium-ion batteries, nickel-cadmium (Ni—Cd) batteries, and nickel-metal hydride (Ni-MH) batteries. In addition, supercapacitors (e.g., supercapacitors 122) may be used as an alternative to batteries.

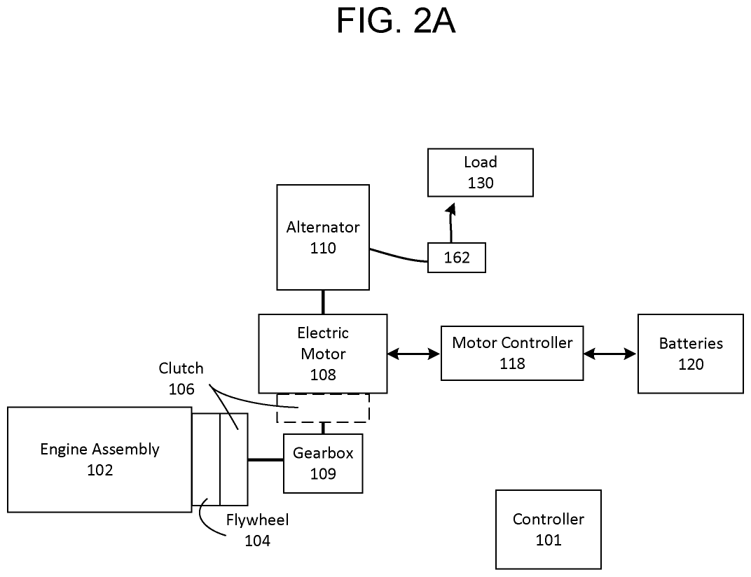

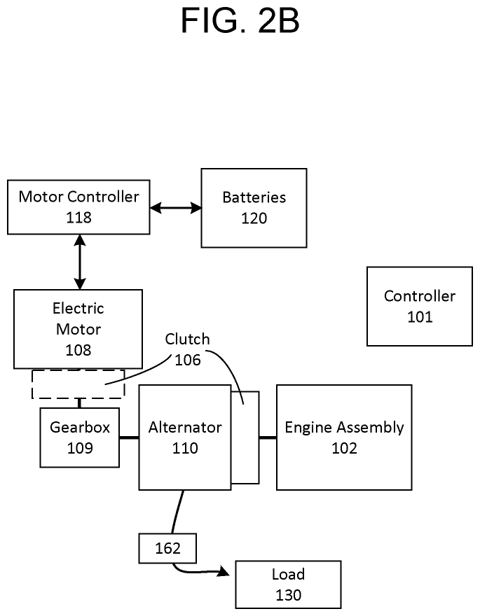

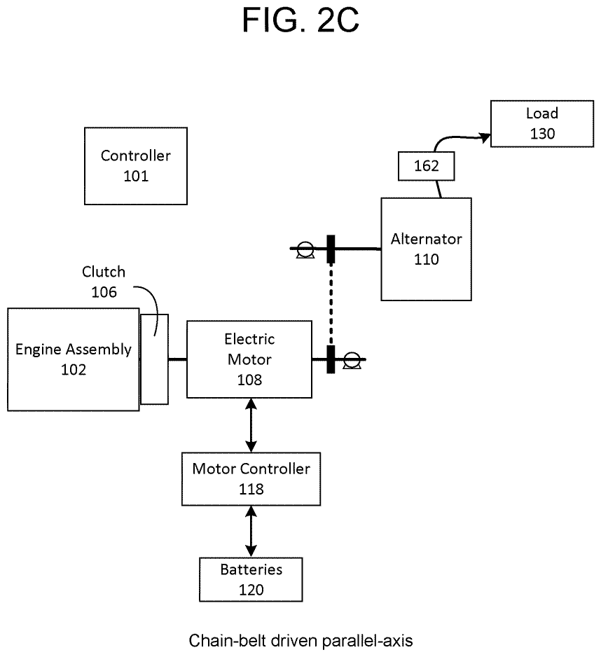

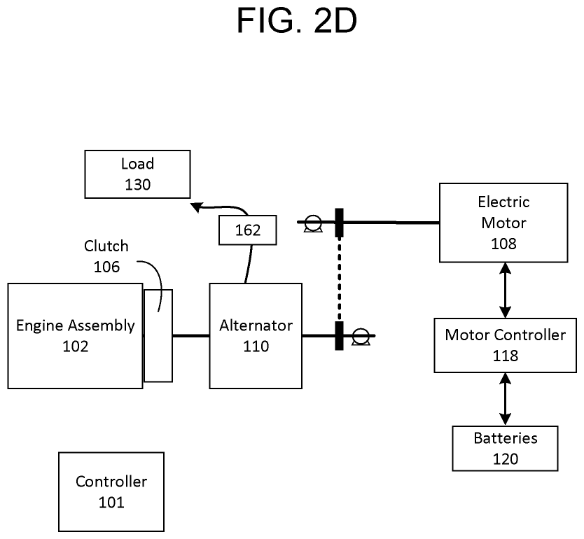

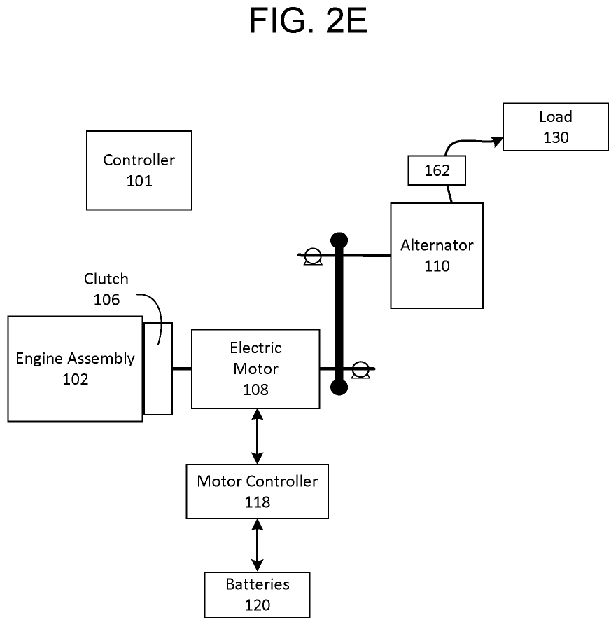

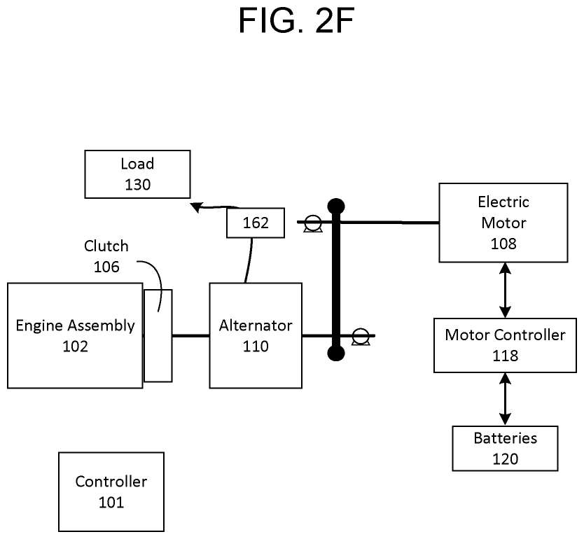

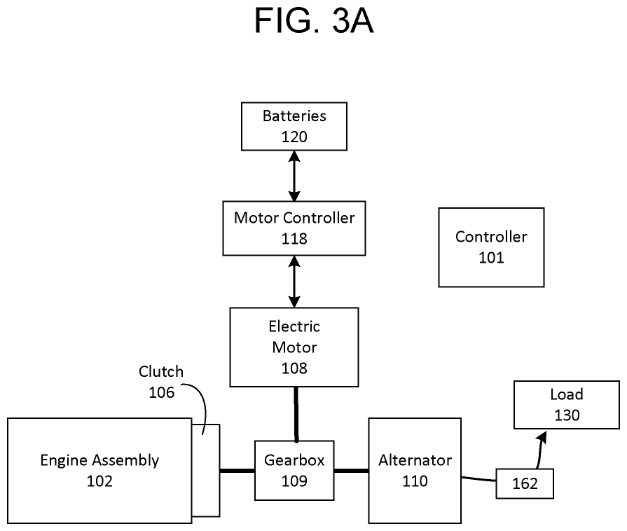

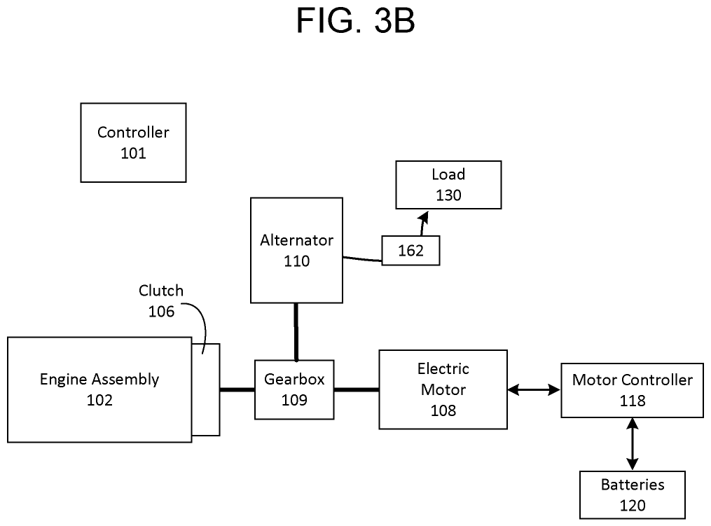

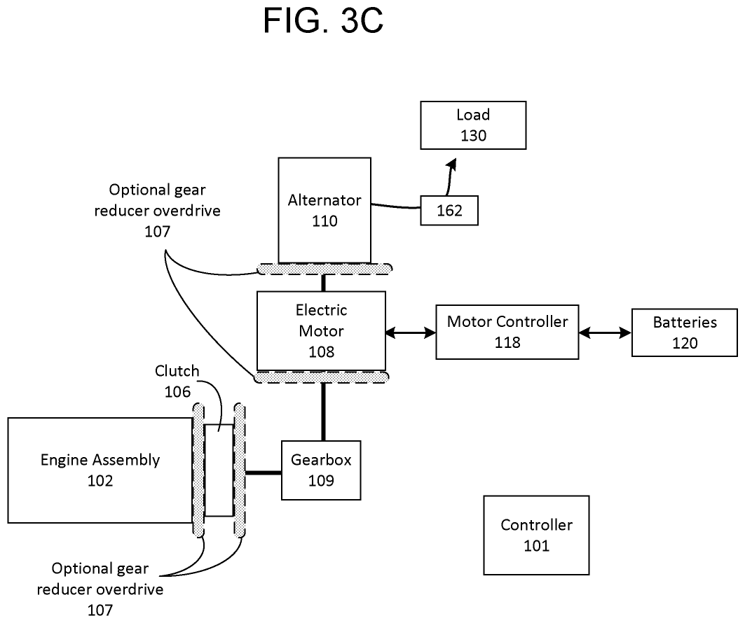

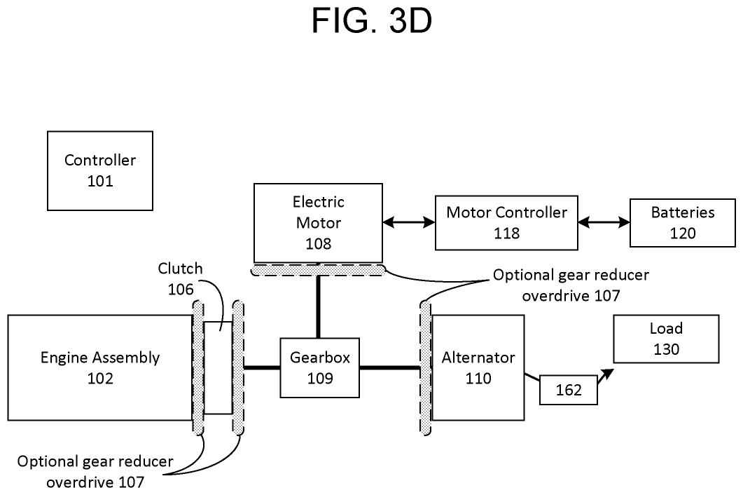

As illustrated in FIGS. 1A and 1B, the electric motor 108 can be physically in-line with the alternator 110 and the engine 102. As illustrated in FIGS. 2A, 2B, and 3A-3D, a gearbox 109 can be used, such that the electric motor 108 can be physically offset from the alternator 110 and/or engine 102. In an alternative embodiment, a chain or belt drive could be used, which would cause either the alternator 110 or the electric motor 108 to be physically offset to the engine's crank shaft (see FIGS. 2C-2F).

As discussed herein, the parallel hybrid energy system 100 may operate in multiple different modes. In an exemplary first mode illustrated in FIG. 9B, referred to as a “charging mode” of the parallel hybrid energy system 100, the batteries 120 are charged. In the charging mode, the controller 101 will turn on the engine 102 (if previously off) and engage (close) the clutching mechanism 106. In the charging mode, the engine 102 is providing all of the power to rotate the electric motor 108 and the alternator 110. In the charging mode, the electric motor 108 is charging the batteries 120 through the motor controller 118. In one embodiment, the controller 101 will begin the charging mode (e.g., when transitioning from the discharging mode to the charging mode) by turning on the engine 102. Once the rotational speed (RPM) of the engine 102 matches the rotational speed (RPM) of the electric motor 108, the controller 101 will engage (close) the clutching mechanism 106 and command the motor controller 118 to enter the battery charging mode.

In an exemplary second mode illustrated in FIG. 9A, referred to as a “discharging mode” of the parallel hybrid energy system 100, power from the batteries 120 are used to power the electric motor 108 to rotate the alternator 110 and provide power to the load 130. In the discharging mode, the controller 101 will turn the engine 102 off and disengage (open) the clutching mechanism 106, such that the electric motor 108 rotates the alternator 110 using power provided by the batteries 120 through the motor controller 118. In one embodiment, the controller 101 will begin the discharging mode (e.g., when transitioning from the charging mode to the discharging mode) by providing power to the electric motor 108 such that the electric motor 108 begins to rotate. Once the electric motor 108 is rotating at or above a selected RPM, the controller 101 will disengage (open) the clutching mechanism 106 and turn the engine 102 off. In another embodiment, the controller will disengage (open) the clutching mechanism 106 and turn off the engine 102 once the electric motor 108 is rotating at a selected RPM that exceeds the rotational speed of the engine 102 by a selected amount. In yet another embodiment, the controller will disengage (open) the clutching mechanism 106 and turn off the engine 102 once the electric motor 108 is rotating at an RPM sufficient for the electric motor's power output to match or exceed the engine's power output. Once the clutching mechanism 106 has been disengaged (open), the controller 101 will select a rotational rate (RPM) for the electric motor 108 to provide a desired output frequency (from the alternator 110).

In an exemplary third mode illustrated in FIG. 9C, referred to as a “peak power mode” of the parallel hybrid energy system 100, the engine 102 and the electric motor 108 are used together to power the load 130. In the peak power mode, the controller 101, in response to an electrical load (e.g., load 130) exceeding the ability of the electric motor 108 or the engine 102 alone to support the load 130, the controller will select the peak power mode. In the peak power mode, as controlled by the controller 101, the clutch 106 is engaged and the engine 102 is running, while both the engine 102 and the electric motor 108 provide power (torque) to rotate the alternator 110 powering the load 130. That is, both the electric motor 108 and the engine 102 together are rotating the alternator 110 to meet the increased load demand (e.g., load 130). In the peak power mode, the controller 101 will start the engine 102 if the engine 102 was previously turned off.

In an exemplary fourth mode illustrated in FIG. 9D, referred to as “fault bypass mode” of the parallel hybrid energy system 100, the alternator 110 is rotated by engine power only. In the fault bypass mode, the system (e.g., via the controller 101) has detected a fault such as a component failure with any combination of the electric motor 108, motor controller 118, and batteries 120. In the fault bypass mode, as controlled by the controller 101, the clutch 106 is engaged (closed) and the engine 102 is running, such that the alternator 110 is rotated by engine power only.

In an exemplary fifth mode illustrated in FIG. 9E, referred to as an “environmental conditions bypass mode” of the parallel hybrid energy system 100, the alternator 110 is rotated by engine power only. The environmental conditions bypass mode is selected by the controller 101 due to ambient environment conditions (extreme heat or cold), where one or more of the electric motor 108, the motor controller 118, or the batteries 120 are outside of their operating temperature range(s). In one embodiment, each component of the parallel hybrid energy system 100 has an operational range defined by a corresponding high temperature threshold and a low temperature threshold. In the environmental conditions bypass mode, the clutch 106 is engaged, the engine 102 is running, and the alternator 110 is rotated by engine power only. In the environmental conditions bypass mode, when operating in extreme cold, heat transfer from the operation of the engine 102 will eventually bring the temperatures of the components (of the parallel hybrid energy system 100) into their operational ranges. Likewise, when operating in extreme heat, falling ambient temperatures and heat transfer out of the components (of the parallel hybrid energy system 100) will eventually bring the temperatures of the components into their operational range(s). That is, the ambient temperature and the operational conditions of the parallel hybrid energy system 100 will affect the temperatures of the components (e.g., engine 102, electric motor 108, alternator 110, motor controller 118, and batteries 120) of the parallel hybrid energy system 100.

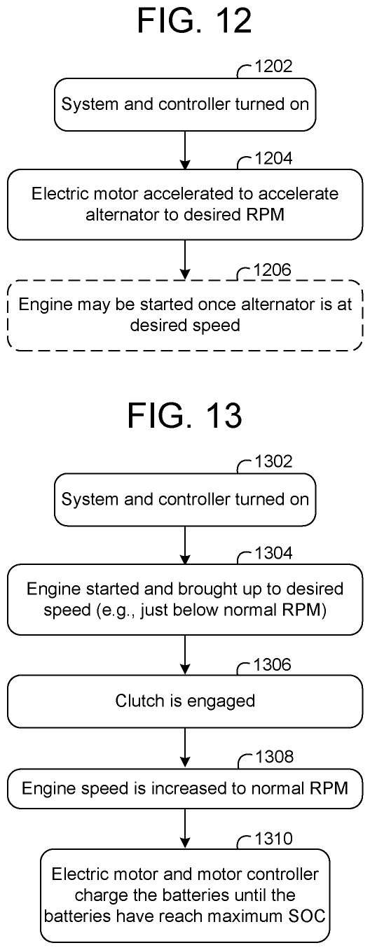

FIG. 12 is a flow diagram illustrating the steps to an exemplary normal startup procedure, while operating in normal conditions (no faults, and all components are in their normal operating ranges), in one exemplary embodiment, the following steps will be carried out.

In step 1202, a first step of the normal startup procedure, the system 100 and controller 101 will be turned “on.” By default, the clutch 106 is disengaged (open). Thus, with no power, the clutch 106 should be “normally open.”

In step 1204, a second step of the normal startup procedure, the electric motor 108 will be quickly accelerated such that the coupled alternator 110 will be quickly accelerated up to the desired speed (RPM).

In step 1206, an optional third step of the normal startup procedure, the engine 102 may be started once the alternator 110 is at the desired speed. For example, this may be done if the battery 120 is at a low state of charge (but not over-discharged) such that the expected engine runtime to bring the battery 120 to a full state of charge is equal to or greater than 30 minutes.

FIG. 13 is a flow diagram illustrating the steps to an exemplary alternative to the normal startup procedure (an “alternative startup procedure”), when the batteries 120 are in an over-discharged state, in one exemplary embodiment, the following steps will be carried out.

In step 1302, a first step of the alternative startup procedure, the system 100 and controller 101 will be turned “on.” By default, the clutch 106 is disengaged (open). Thus, with no power, the clutch 106 should be “normally open.”

In step 1304, a second step of the alternative startup procedure, the engine 102 will be started and brought up to a speed less than the normal operating RPM, for example, 1500 RPM.

In step 1306, a third step of the alternative startup procedure, the clutch 106 will be engaged.

In step 1308, a fourth step of the alternative startup procedure, the engine speed will quickly increased to the normal operating speed.

In step 1310, a fifth step of the alternative startup procedure, the electric motor 108 and the motor controller 118 charge the batteries 120 until the batteries 120 have reached a maximum state of charge.

Likewise, there is also an exemplary shutdown procedure (which begins when a shut-down is initiated), with the following steps to be carried out. Note that there are a few variations depending on the current state of the system 100 at shutdown. In a first variation, the engine 102 is running when the shut-down is initiated (“engine running variation”). If the engine 102 was running when the shutdown was ordered, it can be assumed that the battery 120 was being charged, therefore, the battery 120 should have enough power for a later startup procedure to spin the alternator at 1800 RPM so that the clutch 106 is not abused. In a second variation, the engine 102 is off when the shutdown was ordered. This means that the load (e.g., load 130) was being supplied by the batteries 120 (via the motor controller 118 outputting power to the electric motor 108 to rotate the alternator 110). In a third variation, shutdown is initiated with the use of an E-stop command (e.g., an operator or user pressing an E-stop button). An exemplary E-stop (also known as an emergency stop device) is a safety device used in industrial settings that provides for an immediate operational halt to machinery/equipment in use and coupled to the E-stop.

In one exemplary embodiment, an exemplary shutdown procedure includes a visual countdown (e.g., displayed on a control panel) indicating the time remaining before a complete shutdown of the system 100. The displayed “countdown” will begin once the shutdown procedure has been initiated (indicating that the system 100 is shutting down). When the countdown completes, the shutdown procedure will have completed (e.g., the engine 102 will have been turned off after a cooldown period), and power is cut to the controller 101 and the system 100 powered down.

In a first step of the “engine running” variation of the shutdown procedure, load contactors 162 will be opened (by the controller 101). With the opening of the load contactors 162, the load (e.g., load 130) is disengaged from the output of the alternator 110. Exemplary load contactors 162 are illustrated in FIGS. 1-8 and 10, and it is understood that load contactors 162 may be present between the alternator 110 and the load 130 in any of the embodiments. The load contactors 162 may be a part of the alternator 110 or a separate device for coupling the alternator's power output to the load 130 or for recharging the battery 120.

In a second step of the “engine running” variation of the shutdown procedure, the clutch 106 is disengaged (by the controller 101) and the alternator 110 and electric engine 108 are allowed to slow down to 0 RPM. As the electric engine 108 slows, its power output to the motor controller 118 can be used to charge the batteries 120 during this very brief period.

In a third step of the “engine running” variation of the shutdown procedure, the engine 102 is allowed a proper cooldown and then turned off.

In a fourth step of the “engine running” variation of the shutdown procedure, power is cut to the controller 101 and the system 100 is powered down.

In a first step of the “engine off” variation of the shutdown procedure, the load contactors 162 will be opened (by the controller 101). With the opening of the load contactors 162, the load (e.g., load 130) is disengaged from the output of the alternator 110.

In a second step of the “engine off” variation of the shutdown procedure, with the load contactors 162 open, the bidirectional inverter or converter 118, 119 will switch to charging the battery 120 and the alternator 110 will slow down to 0 RPM while charging the battery 120 during this brief period of time.

In a third step of the “engine off” variation of the shutdown procedure, once the alternator 110 has slowed to 0 RPM, power is cut to the controller 101 and the system 100 is powered down.

In a first step of the “E-Stop” variation of the shutdown procedure, the load contactors 162 will be opened (by the controller 101). With the opening of the load contactors 162, the load (e.g., load 130) is disengaged from the output of the alternator 110.

In a second step of the “E-Stop” variation of the shutdown procedure, with the load contactors 162 open, the bidirectional inverter or converter 118, 119 will switch to charging the battery 120 and the alternator 110 will slow down to 0 RPM while charging the batteries 120 during this brief period of time. Alternatively, the bidirectional inverter or converter 118, 119 would continue charging the battery 120 as the alternator slows. It is understood that if either the engine 102 or the electric motor 108 (or both) were running, the engine 102 would be allowed a proper cooldown and/or electric motor 108 would be turned off.

In a third step of the “E-Stop” variation of the shutdown procedure, once the alternator 110 has slowed to 0 RPM, and the engine 102 has been allowed a proper cooldown (if the engine 102 was running when the E-Stop was initiated), power is cut to the controller 101 and the system 100 is powered down.

Any suitable electric motor 108 can be used. In one embodiment, a right-angle AC or DC motor is used in the system 100. Other electric motor configurations are also anticipated, such as an axial flux motor (pancake motor).

Referring to FIGS. 2A-2F, 3A-3D, and 5D, in an alternative parallel hybrid energy system 100, the engine 102, alternator 110, electric motor 108, and clutch mechanism 106 can be off-axis to each other via right-angle components or an off-axis belt/chain or a right-angle gear driven electric motor 108. For example, with reference to FIGS. 2A-2F, 3A-3D, and 5D, the parallel hybrid energy system 100 can include an electric motor 108 configured as a right-angle electric motor, or a gearbox 109 is positioned between the engine 102 and the electric motor 108. As discussed herein, the gearbox 109 can be coupled to the engine 102 via a gear reducer or gear overdrive 107 (see FIGS. 1A, 3C, and 3D). These alternative embodiments of the parallel hybrid energy system 100 provide for a variety of different component configurations/arrangements. For example, in FIG. 1A, the engine's flywheel 104 can be coupled to the clutch 106, which is coupled to a gear reducer or gear overdrive 107, which is coupled to the gearbox 109. Both the electric motor 108 and the alternator 110 can be coupled to the gearbox 109, such that the gearbox 109 includes a single input and two outputs (the electric motor 108 and alternator 110) (see FIG. 3A). The embodiment illustrated in FIG. 2B illustrates the engine 102 in line with the alternator 110, while the electric motor 108 (via the gear box 109) is orthogonal to the direction of the engine 102 and alternator 110. With the use of one or more gear reducer or gear overdrives 107, an optimization of motor 108 and/or engine 102 RPM efficiency is possible (see FIGS. 1A, 3C, and 3D. For example, gearing coupled between the motor 108 and the alternator 108 ensures the RPM of the alternator 108 provides the required frequency desired (e.g., 50/60/400 Hz).

Referring to FIGS. 2C-2F, in further alternative embodiments of the parallel hybrid energy system 100, the electric motor 108 may be coupled to the alternator 110 via a chain or belt drive. As illustrated in FIGS. 2C-2F, the use of the chain or belt drive causes the alternator 110 or the electric motor 108 to be physically offset to the engine's crank shaft. In FIG. 2C, the electric motor 108 is in-line with the engine 102, while the alternator 110 is coupled to the electric motor 108 via a chain drive such that the alternator 110 is physically offset to the engine's crank shaft. In FIG. 2D, the alternator 110 is in-line with the engine 102, while the electric motor 108 is coupled to the alternator 110 via a chain drive such that the electric motor 108 is physically offset to the engine's crank shaft. In FIG. 2E, similar to FIG. 2C, the electric motor 108 is in-line with the engine, while the alternator 110 is coupled to the electric motor 108 via a belt drive such that the alternator is physically offset to the engine's crank shaft. In FIG. 2F, similar to FIG. 2D, the alternator 110 is in-line with the engine 102, while the electric motor 108 is coupled to the alternator 110 via a belt drive such that the electric motor is physically offset to the engine's crank shaft.

FIGS. 3A-3D illustrate further alternative embodiments of the parallel hybrid energy system 100. In FIG. 3A, a single input, single output gearbox 109 is coupled between the engine 102 and the alternator 110, with the electric motor 108 coupled to the gearbox 109 such that electrical motor 108 is orthogonal to the alternator 110 and the engine 102. With reference to FIGS. 1A, 2A, 2B, 3C, and 3D, a flywheel 104 may be coupled to a clutching mechanism 106, which may be coupled to a gear reducer or gear overdrive 107, and with a gearbox 109 coupled to the gear reducer or gear overdrive 107. That is, the exemplary gear reducer or gear overdrive 107 of FIG. 1A may be positioned between any of the engine assembly 102, electric motor 108, and the alternator 110. In a similar fashion, FIG. 2A illustrates an electric motor 108 coupled (via a clutch 106) to a flywheel 104 of an engine assembly 102. Note that the electric motor 108 and the alternator 110 illustrated in FIG. 2A are positioned orthogonal to the engine 102 via a gearbox 109.

FIG. 3B illustrates a further embodiment of the parallel hybrid energy system 100. In FIG. 3B, a single input, dual output gearbox 109 is a coupled between the engine 102 and the electric motor 108 such that the engine 102 and the electric motor 108 are arranged in-line, while the alternator 110 (also coupled to the gearbox 109) is orthogonal to the engine 102. FIG. 3C illustrates another exemplary embodiment of the parallel hybrid energy system 100. In FIG. 3C, a single input, single output gearbox 109 is coupled between the engine 102 and the electric motor 108, and with the alternator 110 mechanically coupled to the opposite side of the electric motor 108 such that both the electrical motor 108 and alternator 110 are arranged in line and orthogonal to the engine 102.

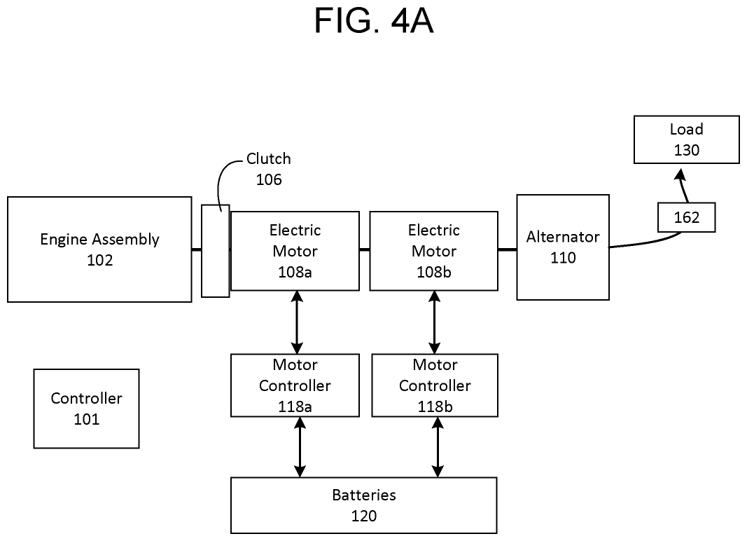

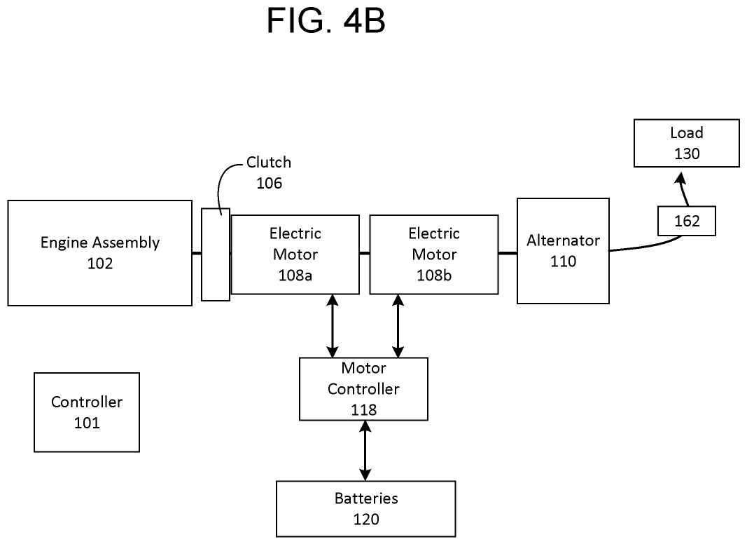

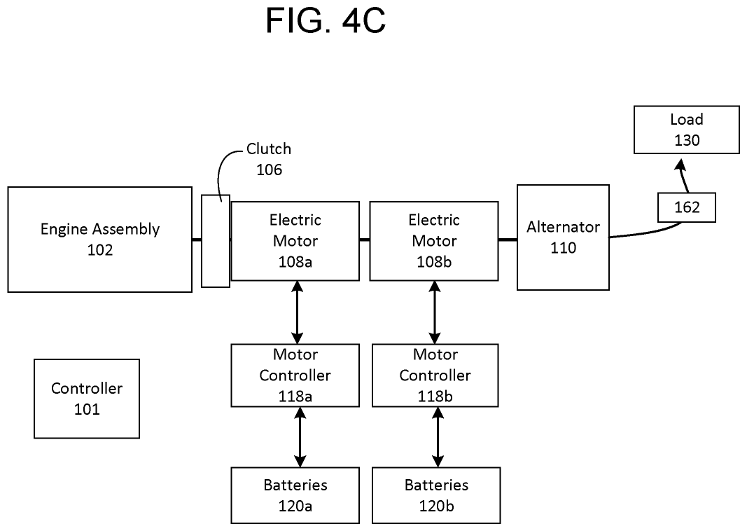

FIGS. 4A-4C illustrate further alternative embodiments that incorporate multiple electric motors 108, motor controllers 118, and batteries 120. FIG. 4A illustrates two or more electric motors (e.g., electric motors 108a, 108b) each with a dedicated motor controller (e.g., motor controllers 118a, 118b), and with the motor controllers 118a, 118b share the same batteries. FIG. 4B illustrates multiple electric motors (e.g., electric motors 108a, 108b) sharing a common motor controller 118 and common batteries 120. FIG. 4C illustrates two or more electric motors (e.g., electric motors 108a, 108b), each coupled to a respective dedicated motor controller (e.g., motor controllers 118a, 118b) and a respective dedicated battery (e.g., batteries 120a, 120b). While FIGS. 4A-4C illustrate a pair of electric motors (e.g., electric motors 108a, 108b), it is understood that these exemplary embodiments may include two or more of the electric motors 108, motor controllers 118, and batteries 120.

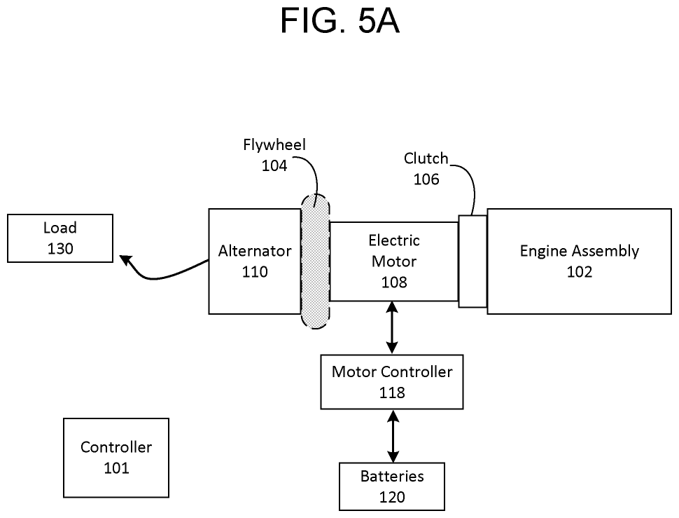

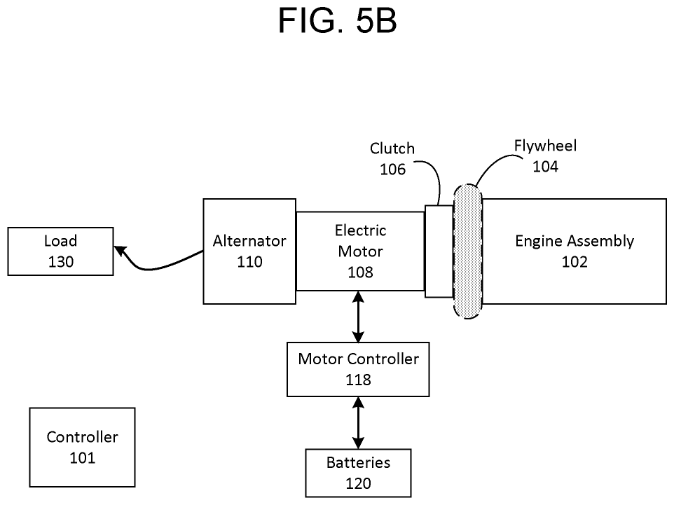

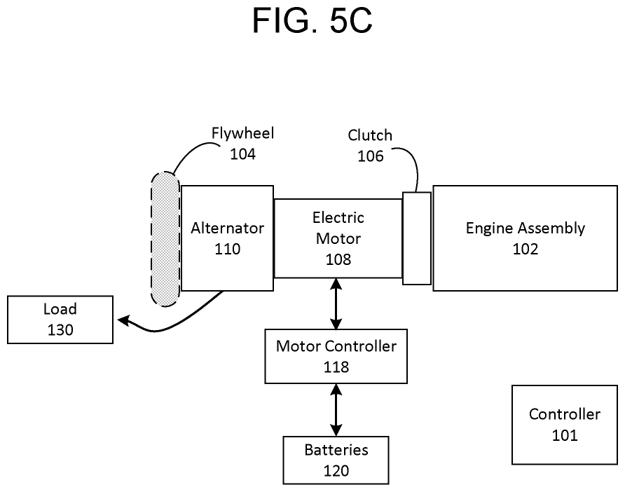

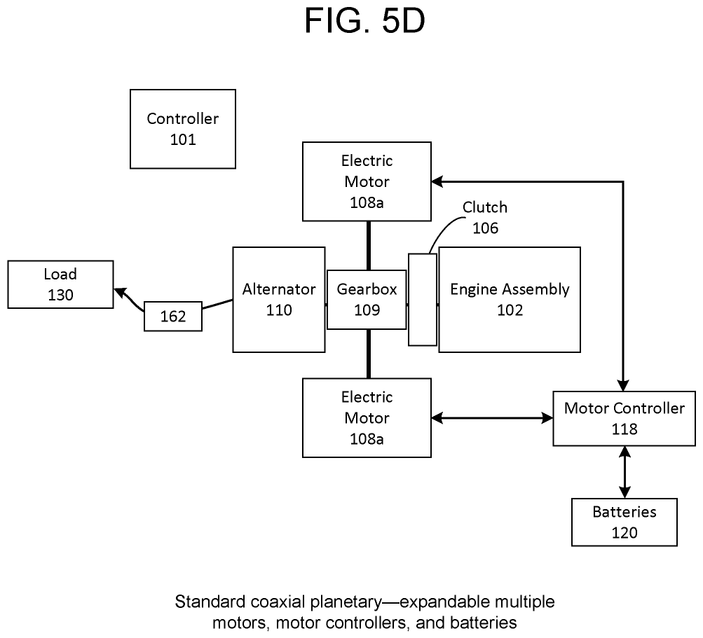

FIG. 5A-5C illustrate further alternative embodiments that incorporate an inertial energy storage flywheel. FIG. 5A illustrates an embodiment that incorporates an inertial storage flywheel 104 positioned between the alternator 110 and the electric motor 108. FIG. 5B illustrates an embodiment that incorporates an inertial storage flywheel 104 positioned between the engine assembly 102 and the electric motor 108. FIG. 5C illustrates an embodiment that incorporates an inertial storage flywheel 104 positioned adjacent to the alternator 110.

FIG. 5D illustrates a further embodiment that incorporates multiple electric motors (e.g., electric motors 108a, 108b) integrated into a planetary gearbox 109.

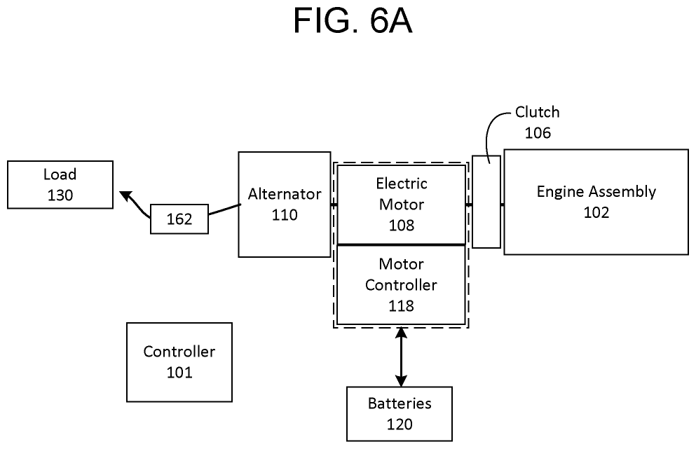

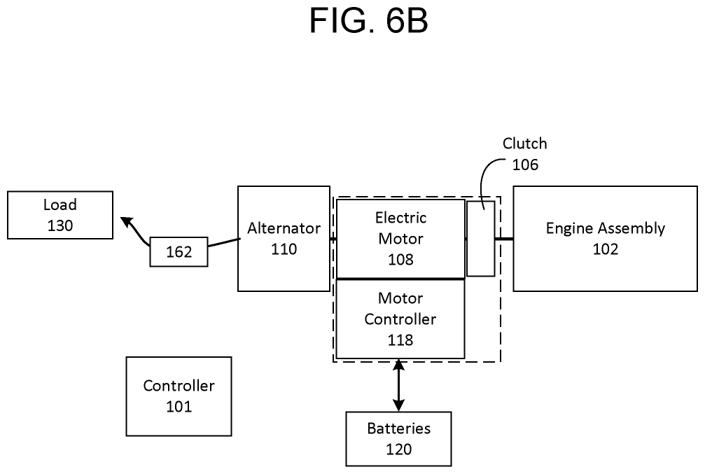

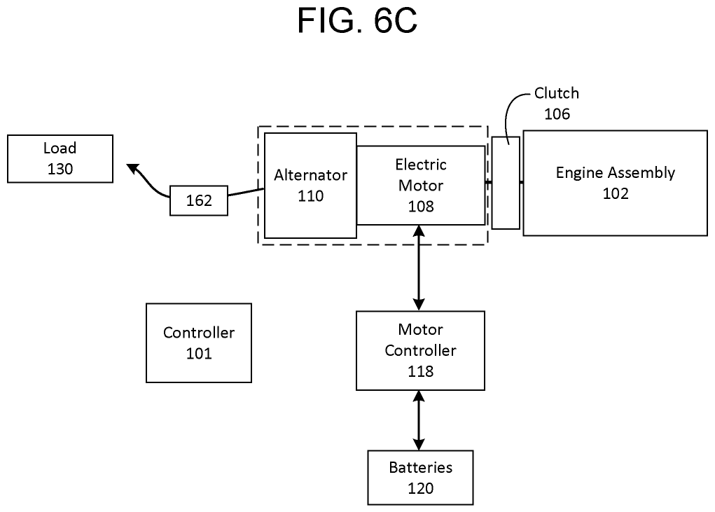

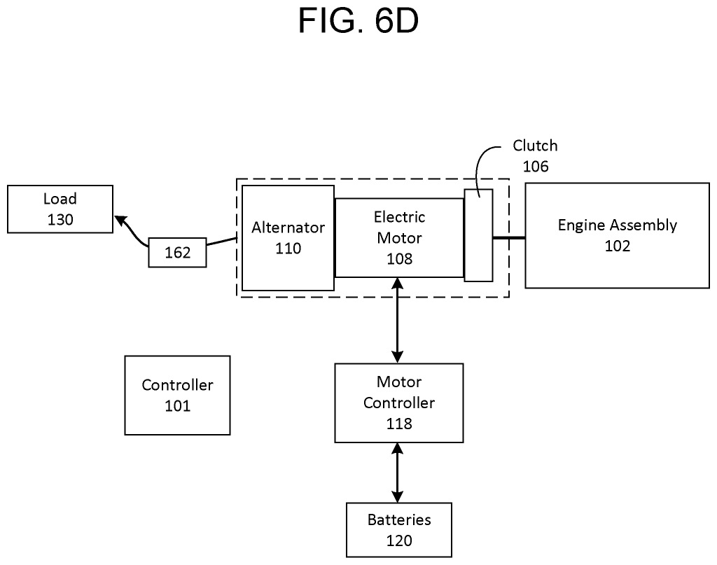

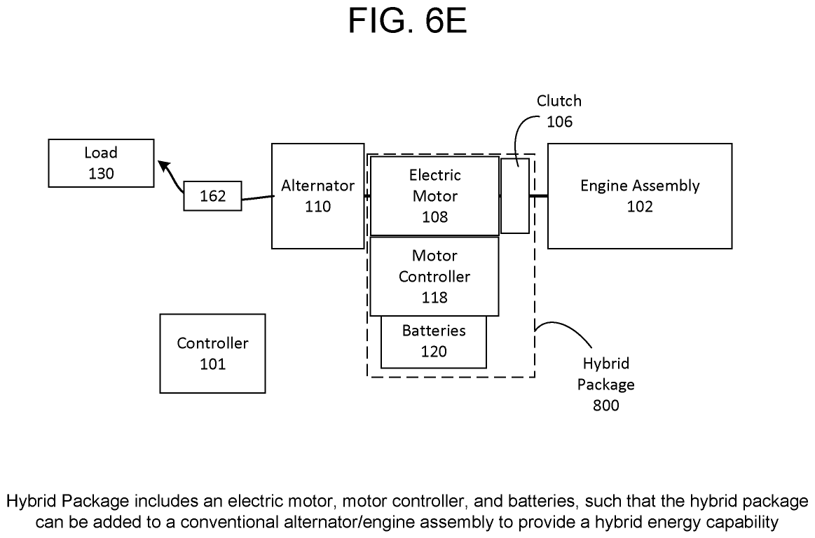

FIG. 6A-6E illustrate further embodiments that incorporate an exemplary packaging configuration for the alternator 110, the electric motor 108, the motor controller 118 and the clutching mechanism 106. FIG. 6A illustrates the electric motor 108 and motor controller 118 in a single assembly. FIG. 6B illustrates the electric motor 108, the motor controller 118, and the clutching mechanism 106 in a single assembly. FIG. 6C illustrates the alternator 110 and the electric motor 108 in a single assembly. FIG. 6D illustrates the alternator 110, the electric motor 108, and the clutching mechanism 106 in a single assembly. The exemplary embodiments illustrated in FIGS. 6A-6E may be integrated into a parallel hybrid energy system 100 in any desired configuration or arrangement, such as illustrated in any of the exemplary embodiments described herein.

FIG. 6E illustrates an exemplary “hybrid package” comprising an electric motor 108, a motor controller 118, and batteries 120 in a single hybrid assembly 800. In one exemplary embodiment, the hybrid assembly 800 provides for the addition of a hybrid package (e.g., hybrid assembly 800) to be added to a conventional alternator/engine assembly to realize an exemplary parallel hybrid energy system 100. As illustrated in FIG. 6E, by placing the hybrid assembly 800 between the alternator 110 and the engine assembly 102, a conventional genset can be converted into a parallel hybrid energy system 100. In one embodiment, the components of the hybrid assembly 800 are integrated into a single housing which is arranged with respect to the alternator 110 and the engine assembly 102. In another embodiment, the components of the hybrid assembly 800 are arranged in two or more housings that are arranged with respect to the alternator 110 and the engine assembly 102.

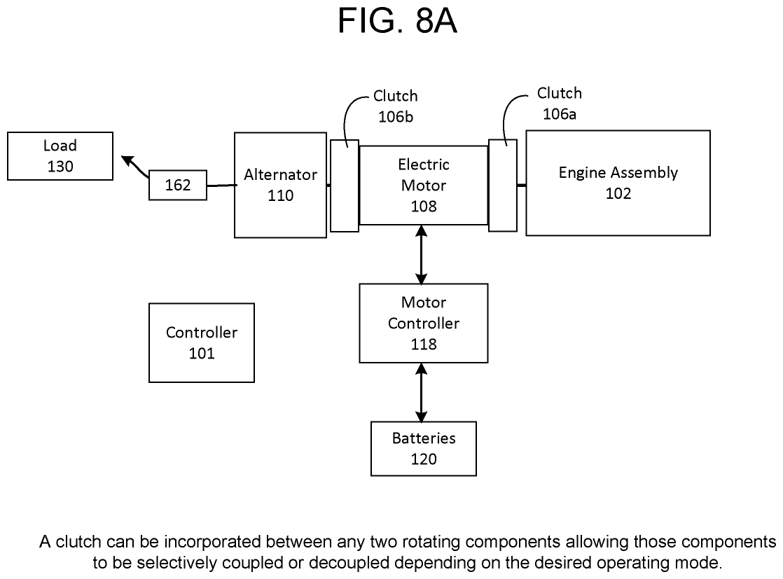

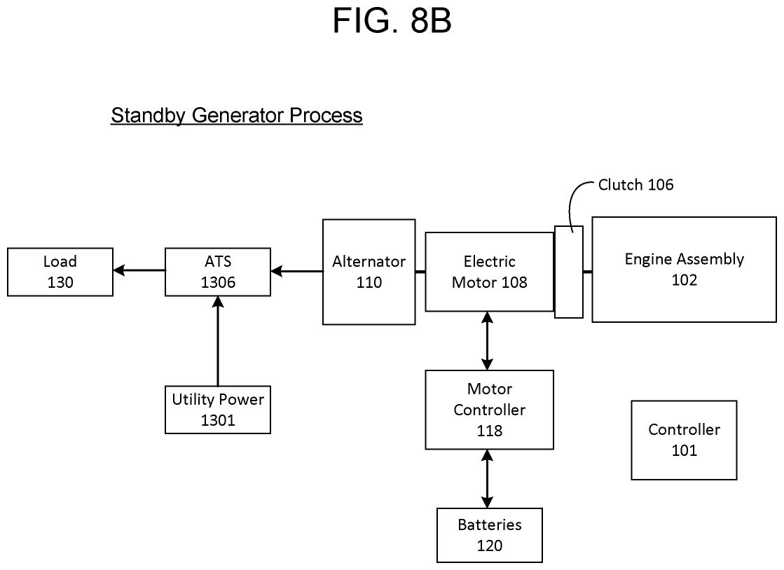

FIG. 7 illustrates a further exemplary embodiment of the parallel hybrid energy system 100. As illustrated in FIG. 7, in one embodiment, the motor controller 118 is coupled to both the batteries 120 and external batteries 121. Alternatively, or in addition, the motor controller 118 may also be coupled to both the batteries 120 (and optionally the external batteries 121) and a supercapacitor 122. While FIG. 7 illustrates optional external batteries 121 or a supercapacitor 122 coupled to the motor controller 118 (along with the batteries 120), in other exemplary embodiments, the batteries 120 may be replaced by the supercapacitor 122. Alternatively, the batteries 120 may incorporate the supercapacitor 122. In a further alternative, the external batteries 121 may incorporate the supercapacitor 122. FIG. 8A illustrates a further alternative embodiment that illustrates the alternative placement of clutches (e.g., clutching mechanisms 106a, 106b) between the alternator 110 and the electric motor 108, and between the electric motor 108 and the engine assembly 102, respectively. Thus, as illustrated in FIG. 8A, a clutch 106 can be incorporated between any two rotating components allowing those components to be selectively coupled or decoupled depending on the desired operating mode of the parallel hybrid energy system 100.

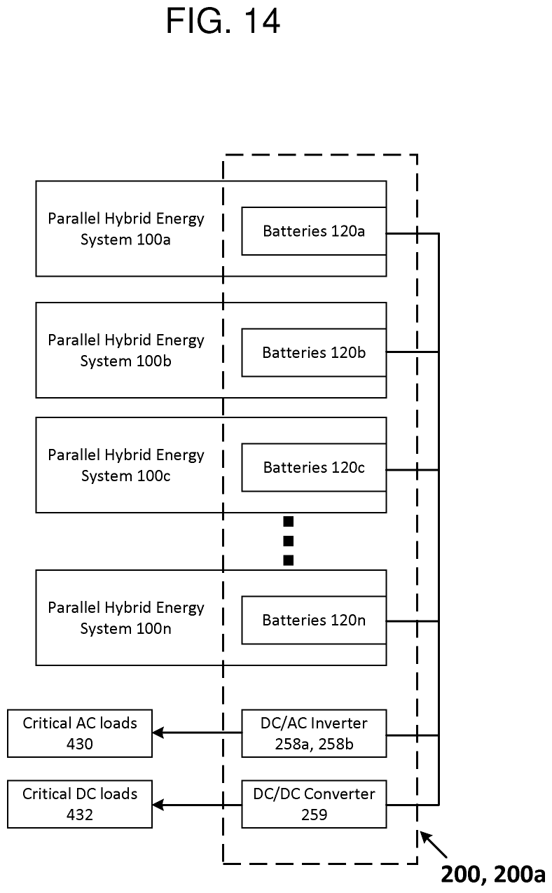

Accordingly, as described herein, the components of a parallel hybrid energy system embodiment 100 may therefore be configured or arranged in a variety of different configurations. For example, as illustrated in FIGS. 1A and 1B, the engine assembly 102, alternator 110, and electric motor 108 may be arranged in any order and in a variety of different packaging configurations (see FIGS. 1A, 1B, 2A-2F, 3A-3D, 5D, and 6A-6E). As discussed herein, the components may be arranged in-line or in an off-axis or orthogonal position with respect to each other (see FIGS. 1A, 1B, 2A-2F, 3A-3D, and 5D). As illustrated in FIGS. 2A, 2B, 3A-3D, and 5D, the parallel hybrid energy system 100 may also include a gearbox 109 such that one or more of the components can be arranged orthogonally with respect to one or more other components of the parallel hybrid energy system 100. As illustrated in FIGS. 1A, 1A, 2A, 2B, and 8A (as well as discussed herein), the parallel hybrid energy system 100 may be configured with one or more clutch mechanism 106 in different positions (e.g., coupled to the engine assembly 102, the electric motor 108, and/or the alternator 110). As illustrated in FIGS. 2C-2F, the parallel hybrid energy system 100 may also be configured with a chain or belt drive, such that, for example, either the alternator 110 or the electric motor 108 could be physically offset, yet parallel to the engine's crank shaft. As illustrated in FIGS. 1A, 3C, and 3D, the parallel hybrid energy system 100 may also be configured with one or more gear reducer/overdrives 107 and/or a flywheel 104. As also discussed herein, while many of the embodiments discussed herein include only a single electric motor 108, motor controller 118, and set of batteries 120, it is understood that exemplary parallel hybrid energy system embodiments 100 may include one or more of each (see FIGS. 4A-4C). And as also discussed herein, two or more parallel hybrid energy systems 100 may be used in combination to realize a higher power output (see FIG. 14).

### Parallel Hybrid Energy System With Integrated Uninterruptible Power Supply

Referring to FIG. 8B, in one parallel hybrid energy system embodiment 100, an exemplary automatic transfer switch (ATS) 1306 is configured to selectively couple a utility power supply (e.g., utility power 1301) or a power output from the alternator 110 of the parallel hybrid energy system 100 configured to operate as a standby or backup generator. The ATS 1306 continuously monitors the output from the utility power supply 1301. In one embodiment, the ATS 1306 monitors all three phases of a three-phase voltage output, and the frequency of the voltage output. When the parallel hybrid energy system 100 is configured as a standby generator, the clutch 106 would be normally open and disconnecting the engine 102 from the driveline (the electric motor 108 and the alternator 110). Upon a signal from the ATS 1306, the controller 101 signals the motor controller 118 to power the electric motor 108. As discussed herein, in a startup mode, the electric motor 108 and alternator 110 reach a desired rotational speed for a desired frequency output (e.g., 1800 RPM for 60 Hz). In one embodiment, the electric motor 108 and alternator 110 reach the desired RPM in under five (5) seconds. Upon the voltage level and frequency of the voltage output from the alternator 110 stabilizing, the ATS 1306 opens the electrical contacts to the utility power supply 1301 and the load 130 is disconnected from the utility power supply. The ATS 1306 also closes the electrical contacts to the alternator 110 and the alternator 110 begins powering the load 130. As also discussed herein, while the output of the alternator 110 is being powered by the rotational torque of the electric motor 108, the engine 102 is also being started by the controller 101. The engine 102, after warming up, proceeds to reach a target rotational rate (e.g., an exemplary 1800 RPM for a stable 60 Hz and voltage). When the engine output is fully stable, the clutch 106 will engage making the rotational torque from the electric motor 108 and the engine 102 available to rotate the alternator 110 and power the load 130. Depending on load demand and a charge state of the batteries 120, a seamless standby generator operation can be realized. Thus, as described herein, the parallel hybrid energy system 100, when operating in a standby generator mode (also referred to herein as a “discharge mode”), is operable to provide a mode where only the electric motor 108 is rotating the alternator 110. In another mode, the engine 102 and electric motor 108 are both rotating the alternator 110 for a peak demand situation. Lastly, in a charging mode, the engine 102 will be rotating the alternator 110 by itself (to power the load 130) and rotating the electric motor 108 to recharge the batteries 120 (via the motor controller 118).

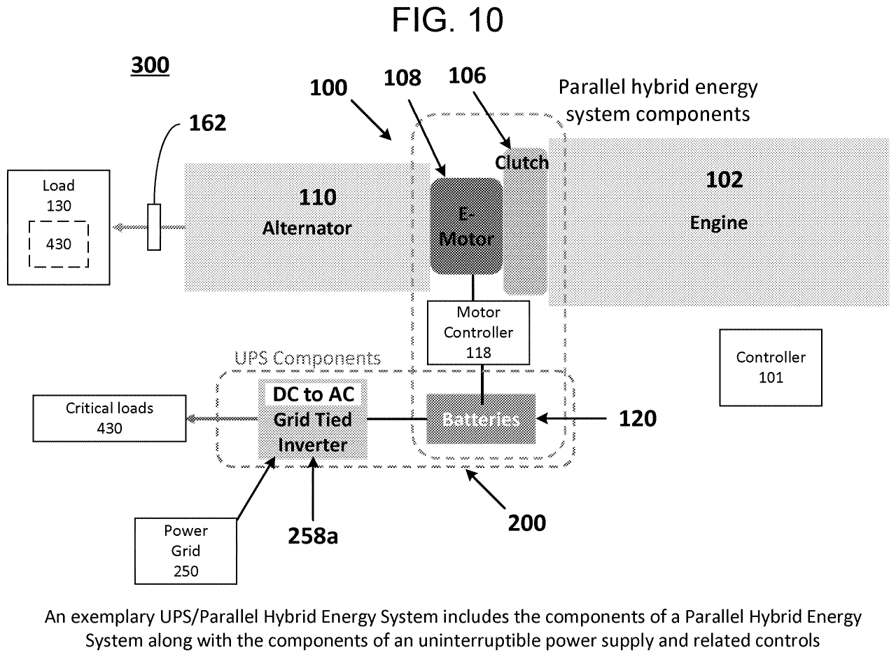

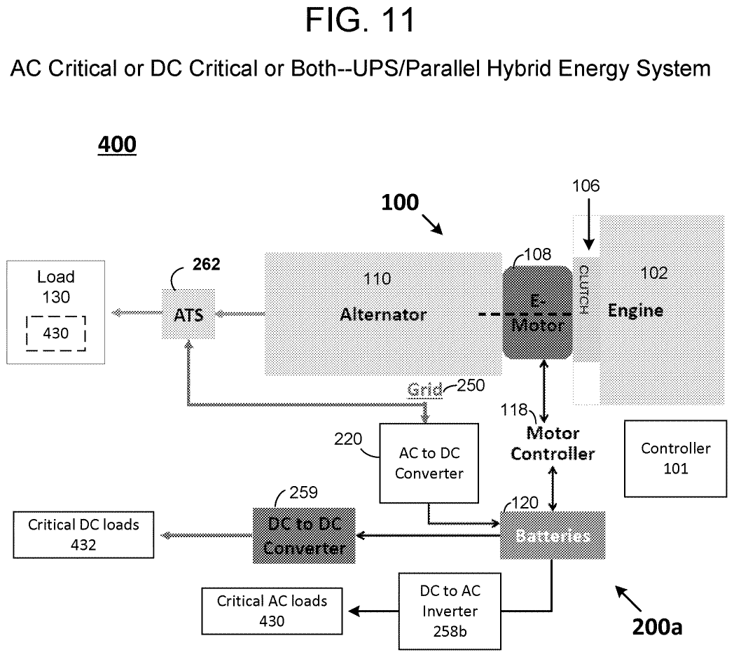

Referring to FIGS. 10 and 11, the parallel hybrid energy system embodiments 100 discussed herein may take advantage of the same benefits as a traditional hybrid energy system but are more economical. For example, the parallel hybrid energy system 100 features greater equipment starting capabilities than a conventional generator alone (e.g., due to instant torque of an electric motor). When used in a standby mode, the electric motor (e.g., electric motor 108) of the parallel hybrid energy system 100 may be configured to provide power within a second (or less) while giving the engine (e.g., engine 102) time for a proper warm up before the engine 102 takes the load (e.g., rotating the alternator 110 to supply power to a load 130) from the electric motor 108. In one embodiment, the parallel hybrid energy system 100 may be paired with a UPS system 200 in an exemplary UPS/parallel hybrid energy system 300 to provide an uninterruptible source of power for critical loads 430 (e.g., an exemplary load 130 can include one or more critical loads 430) (see FIG. 10). Embodiments of the UPS/parallel hybrid energy system 300, 400 are configured to supply power to AC loads 130 and/or DC loads 131, as well as uninterrupted power to critical loads (e.g., critical AC loads 430 and/or critical DC loads 432) (see FIGS. 10 and 11). The batteries 120 of the parallel hybrid energy system 100 are used by the UPS system 200, with the batteries 120 recharged by either a grid connection (grid 250) or by the parallel hybrid energy system 100 (e.g., an alternator 110). In accordance with the various configurations described herein, power from the UPS/parallel hybrid energy system 300, 400 can come from the engine 102, the electric motor 108/batteries 120, or the grid 250, ensuring reliable supply of both AC and DC loads (e.g., AC loads 130, critical DC loads 430, DC loads 131, and critical DC loads 432), with automatic switching and charging capabilities. An automatic transfer switch (ATS) 262 may also be included for routing AC power to the AC load 130, with the ATS 262 interfacing with the grid 250, ensuring backup power and automatic switching (between grid power (e.g., grid 250) and backup power (e.g., from the parallel hybrid energy system 100) (see FIGS. 10 and 11). A controller 101 of the UPS/parallel hybrid energy system 300, 400 coordinates engine 102 start/stop, electric motor 108 engagement, battery 120 charging, and switching logic. Lastly, as described herein, the UPS/parallel hybrid energy system 300, 400 is configured to operate in a variety of modes: an engine mode where the engine 102 drives the alternator 110, supplying AC power to AC loads 130 and charges the batteries 120. A grid mode where the grid 250 powers AC loads 130 directly and recharges the batteries 120. A backup mode where the batteries 120 supply power to critical DC loads 432 and critical AC loads 430 via a DC/DC converter 259 and a DC/AC inverter 258b, respectively, if the AC/grid 250 fails. As discussed herein, in another backup mode, the batteries 120 supply power to the electric motor 108 (via the motor controller 118) to rotate the alternator 110 and supply power to the AC loads 130. In this other backup mode, the AC loads 130 will be powered via the electric motor/batteries (rotating the alternator 110) until the engine assembly 102 is started and the clutch mechanism 106 engaged to take the alternator load.

Referring to FIG. 10, an embodiment of the present invention provides an exemplary UPS/parallel hybrid energy system 300 that includes a UPS system 200 (providing uninterruptible power to critical loads (e.g., critical AC loads 430) integrated with a parallel hybrid energy system 100. In the UPS/parallel hybrid energy system 300, an inverter (e.g., inverter 258a) is tied to both a battery 120 of the parallel hybrid energy system 100 as well as a power grid 250. Such an inverter 258a may be referred to as a “grid-tied” inverter as it is tied to a grid (e.g., 250) and can detect (or sense) the loss of power from the grid 250. When power from the grid 250 is lost, the grid-tied inverter 258a receives power from the battery 120 to provide uninterruptible backup power to one or more critical loads (e.g., critical load 430) of loads 130 powered by a grid (e.g., power grid 250). Thus, exemplary embodiments of the UPS/parallel hybrid energy system 300 provide uninterruptible power for critical AC loads 430 while also providing backup power to the loads 130 (via the parallel hybrid energy system 100) when the grid power 250 is lost. For example, when the parallel hybrid energy system 100 is in standby or backup mode, the controls (e.g., controller 101) are on and powered, but the engine 102 and alternator 110 are not rotating and generating electricity (instead, the grid 250 is supplying power to the loads 130). One of the benefits of a parallel hybrid energy system 100 described herein is in the event of a grid power outage, a signal (typically from an automatic transfer switch (ATS)) 262 is provided to the controller 101 that drives the electric motor 108 to quickly spin the alternator 110 to the desired speed to make backup power available (to the loads 130) during or even before the engine 102 even starts. While the engine 102 is warming up, the electric motor 108 can be used to rotate the alternator 110 and provide power to the load 130. This allows the engine 102 time to start up and warm up properly before starting to provide backup power. Allowing the engine 102 to properly warm up can prevent damage or unnecessary wear on the engine 102 and other components of the system 100. Embodiments of the parallel hybrid energy system 100 alone provide such backup power much more quickly than a traditional backup generator, but there will still be an interruption of power due to the ATS 262 switching from grid power (utility power) 250 and signaling for the parallel hybrid energy system 100 to start.

For critical load situations (e.g., critical AC loads 430) where the power must not be interrupted, a UPS system (e.g., the UPS system 200 of the UPS/parallel hybrid energy system 300) is required. By integrating a grid-tied inverter (e.g., DC/AC inverter 258a) (of the UPS/parallel hybrid energy system 300) to the parallel hybrid energy system 100, the grid-tied inverter (DC/AC inverter 258a) is connected to the grid (e.g., power grid 250) and is able to detect a power outage (of grid power) (see FIG. 10). See also FIG. 11, where the UPS/parallel hybrid energy system 400 is illustrated, which supplies power to critical AC loads 430 and critical DC loads 432.

In one embodiment, the DC/AC inverter 258a is a bidirectional device (configured to invert DC to AC in one direction and to rectify AC to DC in the other direction). Thus, when grid power 250 is available, the parallel hybrid energy system 100 (of the UPS/parallel hybrid energy system 300) is on standby and the grid-tied inverter 258a (of the UPS system 200) charges the batteries 120 (of the parallel hybrid energy system 100) to keep them topped off, while also being configured to provide a grid power passthrough, as the grid (e.g., power grid 250) powers the loads 130 (including the critical loads 430).

When grid power 250 is out, the grid-tied inverter 258a detects this loss of power (from the grid 250) and is able to switch from a passthrough mode to a power production mode, e.g., inverting DC voltage output from the battery 120 to AC voltage to power the critical load(s) 430 connected to the integrated UPS system 200 without interruption to those critical loads 430 (see FIG. 10).

When the grid power (from, e.g., power grid 250) is restored, the grid-tied inverter 258a monitors the grid's voltage level and frequency and then adjusts its own output to match both the phase and frequency (sync) before switching back to the passthrough mode, allowing the output from the power grid 250 to pass through (the inverter 258a) and power the loads 130 (including critical loads 430). In one embodiment, while in the passthrough mode, the inverter 258a is also configured to rectify the AC voltage to a DC voltage to recharge the battery 120. Thus, this uninterruptible power (via the UPS system 200) is provided to critical AC loads 430 when grid power (from, e.g., power grid 250) goes down and while the engine 102 of the parallel hybrid energy system 100 of the UPS/hybrid energy system 300 is still being started, warmed up, and readied to provide backup power (to the load 130, which includes the one or more critical loads 430). It is understood that the UPS system 200 of an exemplary UPS/parallel hybrid energy system 300 can be integrated into any of the embodiments discussed herein of the parallel hybrid energy system 100.

Embodiments of the UPS system 200 (of the UPS/parallel hybrid energy system 300) utilize the onboard batteries 120 of the parallel hybrid energy system 100, such that there is no need for additional or separate batteries which may cause added expense and complexity (see FIG. 10). Due to the ability of the parallel hybrid energy system 100 to power on and provide backup power (to the loads 130) much quicker than a conventional standby generator, a large conventional UPS battery is not required, and in this case, embodiments of the UPS system 200 use the onboard batteries 120 of the parallel hybrid energy system 100. Added redundancy and/or added power capability can be achieved by paralleling more than one parallel hybrid energy system 100 together. That is, multiple parallel hybrid energy systems 100, in any of the configurations/arrangements illustrated in FIGS. 1-8, can be used together to provide an added power capability when desired. As illustrated in FIG. 14, the batteries 120 illustrated in FIG. 10 can include the separate batteries 120a-120n from a plurality of parallel hybrid energy systems 100a-100n (such that the batteries 120 illustrated in FIG. 10 are the batteries 120a-120n of a plurality of parallel hybrid energy systems 100a-100n all tied together to the DC/AC inverter 258a). This approach to backup/standby UPS power generation can be much more cost effective than conventional UPS systems and easier to integrate in an application. Furthermore, as discussed herein, exemplary embodiments of the UPS/parallel hybrid energy system 300 provide backup power (for one or more loads 130), while also providing uninterruptible power to one or more critical loads 430 (e.g., while the engine 102 of the parallel hybrid energy system 100 is warming up before taking over to power the load 130). As also discussed herein, the UPS/parallel hybrid energy system 300, 400 is also able to provide backup power to critical DC loads 432 as well.

Referring to FIG. 11, an exemplary UPS/Parallel Hybrid Energy system 400 integrates an exemplary UPS system 200a (such as illustrated in FIG. 10) with a parallel hybrid energy system 100, such that the UPS/Parallel Hybrid Energy system 400 can provide crucial AC or DC power, or both critical AC and DC power. As discussed herein, the parallel hybrid energy system 100 (of the UPS/Parallel Hybrid Energy System 400) can be configured or arranged in any of the configurations discussed herein. The UPS/Parallel Hybrid Energy system 400 is configured to supply both AC loads 130 and critical DC loads 432 and/or critical AC loads 432. The UPS/Parallel Hybrid Energy system 400 is configured to provide backup power to the loads (AC loads 130 and to either or both critical AC loads 430 and DC loads 432) from either the engine 102 or the electrical motor/battery arrangement (e.g., electric motor 108 and battery 120). The UPS system 200a of the UPS/Parallel Hybrid Energy system 400 is also configured to provide uninterrupted power to the critical DC loads 432 (e.g., DC voltage from the batteries 120 is provided via the DC/DC converter 259a to the critical DC loads 432), as well as (or alternatively) provide uninterrupted power to the critical AC loads 430 (e.g., DC voltage from the batteries 120 is converted to AC power via the DC to AC inverter 258b and provided to the critical AC loads 430). The UPS/Parallel Hybrid Energy system 400 is also configured to recharge the batteries 120 from either the power grid 250 or the alternator 110. Similar to the embodiment illustrated in FIG. 10, as illustrated in FIG. 14, the batteries 120 of the UPS system 200a can be a plurality of batteries 120a-120n from a plurality of parallel hybrid energy systems 100a-100n, with the plurality of batteries 120a-120n tied together to the DC/DC converter 259 and the DC/AC inverter 258b of the UPS system 200a.

As illustrated in FIG. 11, an ATS 262 is configured to switch AC power (to the load 130) from either the grid power 250 or the alternator 110 of the parallel hybrid energy system 100 (when operating in backup mode). As discussed herein, in the event of a loss of power from the grid 250, the ATS 262 sends a signal to the controller 101 to activate the parallel hybrid energy system 100 of the UPS/Parallel Hybrid Energy system 400. While the parallel hybrid energy system 100 (of the UPS/Parallel Hybrid Energy system 400) is starting up to provide backup power, the UPS system 200a of the UPS/Parallel Hybrid Energy system 400 is configured to provide uninterrupted power to the critical DC loads 432 and/or the critical AC loads 430. As also illustrated in FIG. 11, power from the grid 250 is also received by an AC/DC converter 220 (operating as a battery charger), with its DC voltage output to the batteries 120 (to recharge the batteries 120). As also illustrated in FIG. 11, critical DC loads 432 and/or critical AC loads 430 receive power (DC power via a DC/DC converter 259 and AC power via the DC/AC inverter 258b, respectively) from the batteries 120, which is kept recharged by either the grid 250 (via the AC/DC converter 220) or a voltage output from the electric motor 108 (when rotated by the engine 102), which passes through the motor controller 118 (which includes a bidirectional device, e.g., a DC/AC inverter or a DC/DC converter depending on the type of electric motor 108). It is also understood that the voltage outputs (e.g., provided by the UPS/Parallel Hybrid Energy System 400 to the load 130, critical AC loads 430, and critical DC loads 432) can be of any range. For example, in one embodiment, the DC voltage may range from 48-770 VDC. Likewise, in another embodiment, the AC voltage may range from 240 VAC to 480 VAC.

In various embodiments, the UPS/Parallel hybrid energy system 400 may be arranged in a variety of different configurations (e.g., providing DC power to DC loads (e.g., DC loads 131), providing AC power to AC loads 130, and providing uninterrupted power to AC loads (e.g., critical AC loads 430) and/or DC loads (e.g., critical DC loads 432). While the UPS/Parallel hybrid energy system 400 includes an ATS 262, an ATS 262 may or may not be utilized. It is understood that either an ATS or some other means can be utilized to switch between grid power (e.g., grid 250) and backup power (e.g., parallel hybrid energy system 100), as well as detecting and/or indicating the loss of grid power to a control system (e.g., controller 101) of a UPS and/or backup power system (e.g., UPS/Parallel hybrid energy system 300, 400).

Thus, the exemplary embodiments discussed herein improve the efficiency of an engine and alternator assembly (e.g., a diesel generator) with the inclusion of an electric motor and battery or batteries. To provide uninterrupted power to critical loads, a UPS system is also included. Such a system (e.g., a UPS/parallel hybrid energy system) supplies power to AC and/or DC loads as well as uninterrupted power to critical loads (e.g., critical AC loads and/or critical DC loads). The batteries of the parallel hybrid energy system are used by the UPS system, with the batteries recharged by either a grid connection or by the parallel hybrid energy system (e.g., an alternator). In accordance with the various configurations described herein, power from the UPS/parallel hybrid energy system can come from the engine, the electric motor/batteries, or the grid, ensuring reliable supply of both AC and DC loads, with automatic switching and charging capabilities. An automatic transfer switch (ATS) may also be included for routing AC power to the AC load, with the ATS interfacing with the grid, ensuring backup power and automatic switching (between grid power and backup power). A controller of the UPS/parallel hybrid energy system coordinates engine start/stop, motor engagement, battery charging, and switching logic. Lastly, as described herein, the UPS/parallel hybrid energy system is configured to operate in a variety of modes: an engine mode where the engine drives the alternator, supplying AC power to AC loads and charges the batteries. A grid mode where the grid powers AC loads directly and recharges the batteries. A backup mode where the batteries supply power to DC loads via a DC/DC converter if the AC/grid fails.

Changes and modifications in the specifically described embodiments can be carried out without departing from the principles of the present invention which is intended to be limited only by the scope of the appended claims, as interpreted according to the principles of patent law including the doctrine of equivalents.

1. An uninterruptible power supply (UPS)/parallel hybrid energy system for providing backup power to a load comprising:
an engine and an alternator, wherein the engine is configured to rotate the alternator, wherein the alternator is configured to output a voltage output to a load when rotated, wherein the load comprises at least one critical load;
a battery;
a first bidirectional device communicatively coupled to a power grid, wherein the first bidirectional device is configured to operate in a passthrough mode, wherein the power grid, via the first bidirectional device, is configured to power the load and to charge the battery while the first bidirectional device is in the passthrough mode;
a power switch configured to selectively couple either the power grid or the alternator to the load for powering the load; and
a controller configured to control the engine and the power switch;
wherein the controller is configured to receive a power loss signal when power is lost from the power grid;
wherein the controller, in response to receiving the power loss signal, is configured to initiate an engine startup such that the engine will rotate the alternator to supply backup power to the load, wherein the controller is configured to command the power switch to couple an output from the alternator to power the load once the engine has warmed up; and
wherein the first bidirectional device is configured to operate in an uninterruptible mode when power from the power grid is lost, such that power from the battery is provided via the first bidirectional device to the at least one critical load.

2. The UPS/parallel hybrid energy system of claim 1 further comprising an electric motor, wherein the electric motor is configured to rotate the alternator, wherein the electric motor is powered by the battery;
wherein the controller, in response to receiving the power loss signal, is configured to power the electric motor such that the electric motor will rotate the alternator to output the voltage output to the load.

3. The UPS/parallel hybrid energy system of claim 2 further comprising a clutch configured to selectively engage the engine to the alternator, wherein the controller is configured to control the operation of the clutch, such that the engine is disengaged from the alternator while the electric motor is rotating the alternator, and wherein the controller is operable to engage the clutch to couple the engine to the alternator once the engine has warmed up.

4. The UPS/parallel hybrid energy system of claim 1, wherein the first bidirectional device is a DC/AC inverter.

5. The UPS/parallel hybrid energy system of claim 4, wherein the critical load is a critical AC load.

6. The UPS/parallel hybrid energy system of claim 5, wherein the critical AC load comprises an AC voltage ranging from 240 VAC to 480 VAC.

7. The UPS/parallel hybrid energy system of claim 4 further comprising a second bidirectional device configured to convert an AC output of the first bidirectional device to a DC output.

8. The UPS/parallel hybrid energy system of claim 7, wherein the critical load is a critical DC load.

9. The UPS/parallel hybrid energy system of claim 8, wherein the critical DC load is a 48VDC load.

10. The UPS/parallel hybrid energy system of claim 8, wherein the critical DC load comprises a DC voltage ranging from 48-770.

11. The UPS/parallel hybrid energy system of claim 7, wherein the second bidirectional device is an AC/DC rectifier.
